(19) United States
(12) Patent Application Publication
(10) Pub. No.: US 2026/0131435 A1
(43) Pub. Date: May 14, 2026

(54) AUTOFEED SCREWDRIVER TOOL ATTACHMENT WITH A CARTRIDGE HOLDER AND A METHOD OF LOADING A CARTRIDGE INTO AN AUTOFEED SCREWDRIVER TOOL

(71) Applicant: Kyocera Senco Industrial Tools, Inc., Cincinnati, OH (US)

(72) Inventors: Greg Gottlieb, Loveland, OH (US); Ryan Distler, Amelia, OH (US)

(73) Assignee: Kyocera Senco Industrial Tools, Inc., Cincinnati, OH (US)

(21) Appl. No.: 19/381,257

(22) Filed: Nov. 6, 2025

Related U.S. Application Data
(60) Provisional application No. 63/718,104, filed on Nov. 8, 2024.

(51) Int. Cl. B25B 23/04; B25B 21/00; F16B 27/00

(52) U.S. Cl. CPC B25B 23/045; B25B 21/00; F16B 27/00

(57) ABSTRACT

An autofeed screwdriver attachment that includes a spool and a spool support. The spool support configured to be fastened to a handle of an autofeed screwdriver. The spool support includes a first panel mounted to a first side of the handle, a second panel mounted to a second side of the handle, and a spool hanger positioned between the first and second panel. The spool includes an elongate shaft and a retainer. The elongate shaft extending vertically from a first end to a second end. The retainer is fastened proximate to the first end of the elongate shaft, and the elongate shaft is removably fitted to the spool hanger proximate to the second end. The spool is configured to retain a screw cartridge above the retainer.

### CROSS-REFERENCE TO RELATED APPLICATIONS

The present application claims priority to provisional patent application Ser. No. 63/718,104, titled “AUTOFEED SCREWDRIVER TOOL ATTACHMENT WITH A CARTRIDGE HOLDER AND A METHOD OF LOADING A CARTRIDGE INTO AN AUTOFEED SCREWDRIVER TOOL,” filed on Nov. 8, 2024.

### TECHNICAL FIELD

The present description relates to a tool for repeatedly feeding individual fastening elements from a supply of a plurality of fastening elements. More specifically, the present description relates to an attachment for holding screws for automatic screwdriving equipment. Embodiments are specifically disclosed as having a strip holder assembly comprising a spool rotatably mounted within a spool support. The spool retains a screw cartridge that includes a screw strip and screws to prevent the screw strip from getting tangled or jammed during use of the automatic screwdriver.

One such embodiment has the screw cartridge is in a coiled orientation so that the screw tips are positioned facing inwards towards the spool, and the spool is positioned parallel relative to the driver. Another embodiment has the spool positioned orthogonally relative to the longitudinal axis of the tool, which also has the screw cartridge in a coiled orientation with the screw tips oriented towards the spool. The cartridge holder ensures that the screw strip feeds into the tool without becoming tangled or jammed, and also facilitates easy replacement of a high number of screws at each loading.

An additional embodiment comprises an attached receptacle support that is attached to the autofeed screwdriver tool to hold a strip receptacle. The strip receptacle retains the “spent” or empty screw strip after fastening the screws into the workpiece. The strip receptacle is a portion of the cartridge container. The cartridge container has functionality in shipping and use. During shipping, the cartridge container ensures that the screw cartridge is safely and securely retained within the cartridge container. Additionally, during operation, the strip receptacle, a portion of the cartridge container, collects the “spent” plastic strips that are fed into the strip receptacle by a guide after the screws are installed into the workpiece.

Yet another embodiment comprises a cartridge holder including a spool support, a spool and a clutch. The clutch enables the screw cartridge to have a predetermined amount of resistance when the screw strips are fed into the tool from the screw cartridge so that the screw strips do not get tangled or jammed when fed into the tool. Also acts as an anti-reverse to prevent back-and-forth motion that loosens the screw cartridge coils around the spool.

Still yet another embodiment comprises a screw cartridge including a plastic strip and a plurality of screws including heads, shafts, and tips. The screw cartridge includes a coiled arrangement including an outside diameter formed by the plastic strip and an inside diameter formed by the tips. The inward orientation of the tips provides safety and reduces the diameter and/or height of the screw cartridge so that more screws may be contained within a single container.

### STATEMENT REGARDING FEDERALLY SPONSORED RESEARCH OR DEVELOPMENT

None.

### BACKGROUND

Several manufacturers of power tools sell automatic-feed (or “autofeed”) fastening tools, and more specifically autofeed screwdriving tools. The autofeed screwdriving tools typically use some type of collated strips that hold multiple screws at fairly precise intervals, and these collated strips of screws are fed into an indexing mechanism at the front portion of the autofeed screwdriving tool. The user has to merely place the front tip of the tool against a workpiece, and then pull the trigger on the tool while pressing the tool against the workpiece. When that occurs, the tool will automatically index a screw to the “driving position,” and a drive bit will begin turning and will be pushed into the head of the screw. The drive bit then forces the screw into the workpiece. This tool automatically pulls another screw from the collated screw strip into the tool so that the drive bit is aligned with another screw for fastening into the workpiece.

The collated screw strips for such tools are either rigid or rigidly supported within a magazine in a particular orientation that limits the number of collated screws that could be loaded into the tool in a single loading, or the collated screw strip would hang from the tool unsupported. This would be less than ideal when the tool is used in an automated machine because the “spent” collated screw strips would either have to be removed from the tool by a human user or would fall from the tool after the last screw was installed in the workpiece. Additionally, the collated screw strips were shipped in a conventional shipping package that would require the collated screw strips to be manually removed and fed into the screwdriving tool. This type of tool is well-known, and often used by professional carpenters and other construction workers.

### SUMMARY

Accordingly, it is an advantage to provide a screw cartridge support structure that enables the screw cartridge to be easily loaded onto an autofeed screwdriver tool with a high number of screws.

It is another advantage to provide a structure capable of retaining a screw cartridge having a high number of screws that is capable of being fed into an auto-feed tool in a trouble free manner so that the screw cartridge does not interfere with the operation of the tool.

It is yet another advantage to provide a structure capable of retaining a high number of screws in a screw cartridge that is capable of being fed into an auto-feed tool in a trouble free manner so that the screw cartridge does not interfere with the working of the tool when the tool is installed within an automated fastening machine.

It is still another advantage to provide a structure capable of retaining a high number of screws in a screw cartridge that number of screws being within the range from approximately 100 to approximately 1000 screws, approximately 200 to approximately 900 screws, approximately 300 to approximately 700 screws, approximately 400 to approximately 600 screws, and more specifically approximately 500 screws that are capable of being fed into an auto-feed tool in a trouble free manner so that the screw strip does not interfere with the working of the tool when the tool is installed within an automated fastening machine.

It is a further advantage to provide a shipping container that serves the dual purpose of (1) providing a container to ship the screw cartridge, and after being installed upon the tool and (2) collecting the “spent” plastic strips after the fastening the screws to the workpiece.

It is a yet further advantage to provide a screw cartridge holder that provides a predetermined amount of resistance to rotation and prevents a screw strip of the screw cartridge from becoming tangled when fed into the autofeed screwdriver.

It is a yet further advantage to provide a clutch that provides a predetermined amount of resistance against an autofeed tool and prevents reverse rotation of the spool so that the screw strip does not become tangled when fed into the tool.

It is a yet further advantage to provide a receptacle support that may quickly and easily retain a shipping container on the tool to collect the “spent” plastic strips after the screws are fastened into the workpiece.

Additional advantages and other novel features will be set forth in part in the description that follows and in part will become apparent to those skilled in the art upon examination of the following or may be learned with the practice of the technology disclosed herein.

To achieve the foregoing and other advantages, and in with one aspect, an autofeed screwdriver attachment is provided, in which the autofeed screwdriver comprises: (a) a spool support configured to be fastened to a handle of an autofeed screwdriver, the spool support including: (i) a first panel mounted to a first side of the handle, (ii) a second panel mounted to a second side of the handle, and (iii) a spool hanger positioned between the first and second panel; and (b) a spool including an elongate shaft extending vertically from a first end to a second end, and a retainer that is fastened proximate to the first end of the elongate shaft and the elongate shaft is removably fitted to the spool hanger proximate to the second end; wherein: the spool is configured to retain a screw cartridge above the retainer.

In accordance with another aspect, an autofeed screwdriver assembly is provided, in which the autofeed screwdriver assembly comprises: (a) an autofeed screwdriver; and (b) a cartridge holder including: (i) a spool support mounted to a handle of the autofeed screwdriver and including: (A) a first panel mounted to a first side of the handle; (B) a second panel mounted to a second side of the handle; and (C) a spool hanger positioned between the first and second panel, (ii) a spool is rotatably fitted within the spool hanger and is configured to retain a screw cartridge, wherein: the screw cartridge includes a flexible screw strip positioned in a coiled configuration that retains a plurality of screws with each individual screw of the plurality of screws evenly spaced apart and having a tip that faces towards the spool.

In accordance with yet another aspect, a method of preparing a screw cartridge to be loaded into a screwdriver assembly is provided, in which the method comprises: (a) providing a container including a receptacle having at least one side panel extending upwards from a base panel to a top and defining an interior space, the base panel having a base aperture, and an insert having an insert aperture positioned between the base panel and the top within the interior space; (b) positioning a screw cartridge within the interior space above the insert, wherein the screw cartridge comprises a flexible screw strip positioned in a coiled arrangement within the interior space; (c) providing a spool extending from a first end to a second end, which includes a retainer proximal to the second end that exhibits a base diameter that is larger than the insert aperture, in which the first end is smaller in diameter than the base aperture and the insert aperture; (d) inserting the spool upwards so that the first end extends through the base aperture, the insert aperture, and the screw cartridge; and (e) displacing spatially the spool upwards through the top of the container to remove the screw cartridge from the container.

In accordance with still another aspect, a screw cartridge is provided, in which comprises: a single screw strip that is flexible and retains a plurality of screws, each screw of the plurality of screws including a head and a tip, each head being retained and spaced apart a set distance from an adjacent head, and the single screw strip being positioned in a coiled arrangement with the tips facing inwards and the single screw strip generally forming an outside diameter of the coiled arrangement, wherein: the plurality of screws includes approximately 400 to approximately 600 screws in the single screw strip; the screw cartridge is configured to be retained for shipping in the coiled arrangement; and the screw cartridge is configured to be loaded upon a spool of an attachment for an autofeed screwdriver in which the coiled arrangement is generally maintained.

Still other advantages will become apparent to those skilled in this art from the following description and drawings wherein there is described and shown a preferred embodiment in one of the best modes contemplated for carrying out the technology. As will be realized, the technology disclosed herein is capable of other different embodiments, and its several details are capable of modification in various, obvious aspects all without departing from its principles. Accordingly, the drawings and descriptions will be regarded as illustrative in nature and not as restrictive.

### BRIEF DESCRIPTION OF THE DRAWINGS

The accompanying drawings incorporated in and forming a part of the specification illustrate several aspects of the technology disclosed herein, and together with the description and claims serve to explain the principles of the technology. In the drawings:

FIG. 1 is a perspective view of an autofeed screwdriver tool assembly including an autofeed screwdriver tool mated with a screw cartridge and a strip receptacle, viewed from the bottom right, in which the tool is depicted in a horizontal orientation.

FIG. 2 is an elevational view from the right side of the autofeed screwdriver assembly of FIG. 1, in which the tool is depicted in a horizontal orientation.

FIG. 3 is a perspective view of the autofeed screwdriver assembly of FIG. 1 viewed from the top, viewed from the top left, in which the tool is depicted in a horizontal orientation.

FIG. 4 is a perspective view of the cartridge holder including a spool and a spool support, viewed from the rear right, in which the spool is depicted in the vertical orientation.

FIG. 5 is an elevational view of the cartridge holder of FIG. 4, viewed from the rear, in which the spool is depicted in the vertical orientation.

FIG. 6 is an elevational view from the right side of the cartridge holder of FIG. 4, in which the spool is depicted in the vertical orientation.

FIG. 7 is an exploded perspective view of the spool shown in FIG. 4, in which the spool is depicted in the vertical orientation.

FIG. 8 is a perspective view of a cartridge container viewed from the bottom.

FIG. 9 is a perspective view of the cartridge container of FIG. 8 viewed from the top.

FIG. 10 is an exploded perspective view of a screw cartridge positioned within the cartridge container of FIG. 8, as viewed from the top.

FIG. 11A is a perspective view of the spool of FIG. 7 being inserted within the bottom of the cartridge container of FIG. 8, as viewed from the top.

FIG. 11B. is a perspective view of the spool of FIG. 7 after being fully inserted within the bottom of the cartridge container of FIG. 8, as viewed from the top.

FIG. 11C is a perspective view of the spool of FIG. 7 and the cartridge container of FIG. 8 after removing the lid from the cartridge container of FIG. 8, as viewed from the top.

FIG. 11D is a perspective view of the spool of FIG. 7 being moved upwards to remove the screw cartridge from the cartridge container of FIG. 8, as viewed from the top.

FIG. 11E is a perspective view of the spool of FIG. 7 and the screw cartridge after being fully removed from the cartridge container of FIG. 8, as viewed from the top.

FIG. 12A is a perspective view of the autofeed screwdriver assembly of FIG. 1 with the spool of FIG. 7 being removed from the spool support of FIG. 4 as viewed from the right rear, in which the tool is depicted in a vertical orientation.

FIG. 12B is a perspective view of the autofeed screwdriver assembly of FIG. 1 with the spool of FIG. 7 after being removed from the spool support of FIG. 4 as viewed from the right rear, in which the tool is depicted in a vertical orientation.

FIG. 12C is a perspective view of the autofeed screwdriver assembly of FIG. 1 with the spool of FIG. 7 after being loaded with the screw cartridge with the procedure shown in FIGS. 11A-11E as viewed from the right rear, in which the tool is depicted in a vertical orientation.

FIG. 12D is a perspective view of the autofeed screwdriver assembly of FIG. 1 with the spool of FIG. 7 being installed within the spool holder loaded with the screw cartridge, as viewed from the right rear, in which the tool is depicted in a vertical orientation.

FIG. 12E is a perspective view of the autofeed screwdriver assembly of FIG. 1 with the screw strip being fed through the guide of the cartridge holder from the screw cartridge as viewed from the right rear, in which the tool is depicted in a vertical orientation.

FIG. 12F is an elevational view from the right side of the autofeed screwdriver assembly of FIG. 1 with the screw strip being further fed through the autofeed screwdriver, and the plastic strips being deposited into a strip receptacle, in which the tool is depicted in a vertical orientation.

FIG. 13A is a perspective view of the strip receptacle support of the autofeed screwdriver assembly of FIG. 1 shown in the open configuration viewed from the left top, in which the receptacle support is depicted in a horizontal orientation.

FIG. 13B is a perspective view of the receptacle support of FIG. 13A fitted with a strip receptacle in the open configuration viewed from the top left, in which the receptacle support is depicted in a horizontal orientation.

FIG. 13C is a perspective view of the receptacle support of FIG. 13A fitted with a strip receptacle in the closed configuration viewed from the top left, in which the receptacle support is depicted in a horizontal orientation.

FIG. 14 is a perspective view of the receptacle support of FIG. 13A fitted with a strip receptacle in the closed configuration viewed from the right top, in which the receptacle support is depicted in a horizontal orientation.

FIG. 15 is a perspective view of the receptacle support of FIG. 13A fitted with a strip receptacle in the closed configuration viewed from the right rear, in which the receptacle support is depicted in a horizontal orientation.

FIG. 16 is an elevational view from the right side of a first alternative embodiment of an autofeed screwdriver assembly including an autofeed screwdriver mated with a transversely positioned cartridge holder and a receptacle support, in which the autofeed screwdriver assembly is depicted in a horizontal orientation.

FIG. 17 is a perspective view of the autofeed screwdriver assembly of FIG. 16 as viewed from the right rear, in which the autofeed screwdriver assembly is depicted in a horizontal orientation.

FIG. 18 is a perspective view of a second alternative embodiment of a cartridge holder including a spool, a spool support, and a clutch, as viewed from the top rear, in which the cartridge holder is depicted in a vertical orientation.

FIG. 19 is a perspective view of a third alternate embodiment of a receptacle support in a closed configuration viewed from the right rear, in which the receptacle support is depicted in a vertical orientation.

FIG. 20 is a perspective view of the receptacle support of FIG. 19 in the open configuration viewed from the left top, in which the receptacle support is depicted in a horizontal orientation.

FIG. 21 is a perspective view of the screw cartridge of FIG. 10 as viewed from the right rear, in which the screw cartridge is depicted in a vertical orientation.

### DETAILED DESCRIPTION

Reference will now be made in detail to the present preferred embodiment, an example of which is illustrated in the accompanying drawings, wherein like numerals indicate the same elements throughout the views.

It is to be understood that the technology disclosed herein is not limited in its application to the details of construction and the arrangement of components set forth in the following description or illustrated in the drawings. The technology disclosed herein is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” or “mounted,” and variations thereof herein are used broadly and encompass direct and indirect connections, couplings, or mountings. In addition, the terms “connected” or “coupled” and variations thereof are not restricted to physical or mechanical connections or couplings. Furthermore, the terms “communicating with” or “in communications with” refer to two different physical or virtual elements that somehow pass signals or information between each other, whether that transfer of signals or information is direct or whether there are additional physical or virtual elements therebetween that are also involved in that passing of signals or information. Moreover, the term “in communication with” can also refer to a mechanical, hydraulic, or pneumatic system in which one end (a “first end”) of the “communication” may be the “cause” of a certain impetus to occur (such as a mechanical movement, or a hydraulic or pneumatic change of state) and the other end (a “second end”) of the “communication” may receive the “effect” of that movement/change of state, whether there are intermediate components between the “first end” and the “second end,” or not. If a product has moving parts that rely on magnetic fields, or somehow detects a change in a magnetic field, or if data is passed from one electronic device to another by use of a magnetic field, then one could refer to those situations as items that are “in magnetic communication with” each other, in which one end of the “communication” may induce a magnetic field, and the other end may receive that magnetic field, and be acted on (or otherwise affected) by that magnetic field.

The terms “first” or “second” preceding an element name, e.g., first inlet, second inlet, etc., are used for identification purposes to distinguish between similar or related elements, results or concepts, and are not intended to necessarily imply order, nor are the terms “first” or “second” intended to preclude the inclusion of additional similar or related elements, results or concepts, unless otherwise indicated.

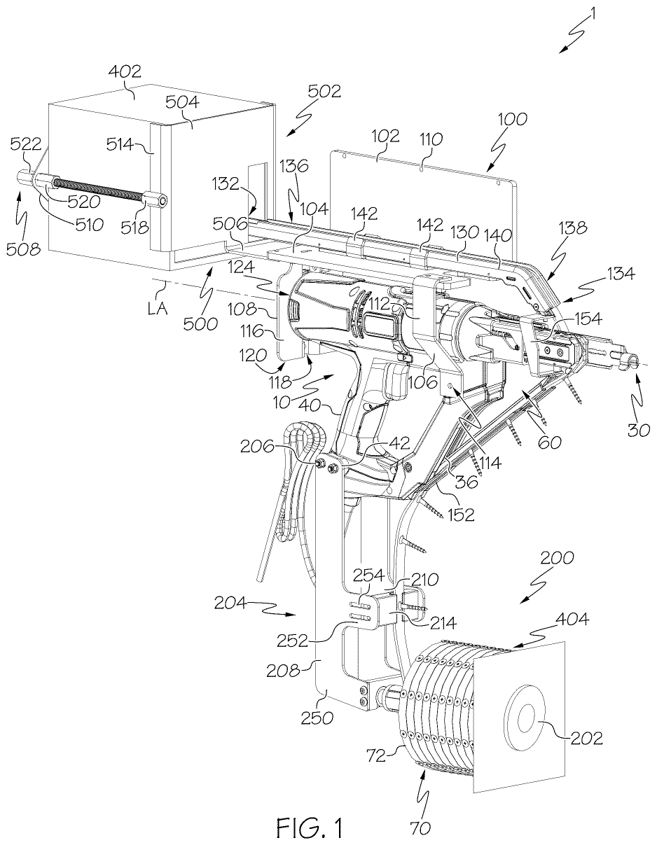

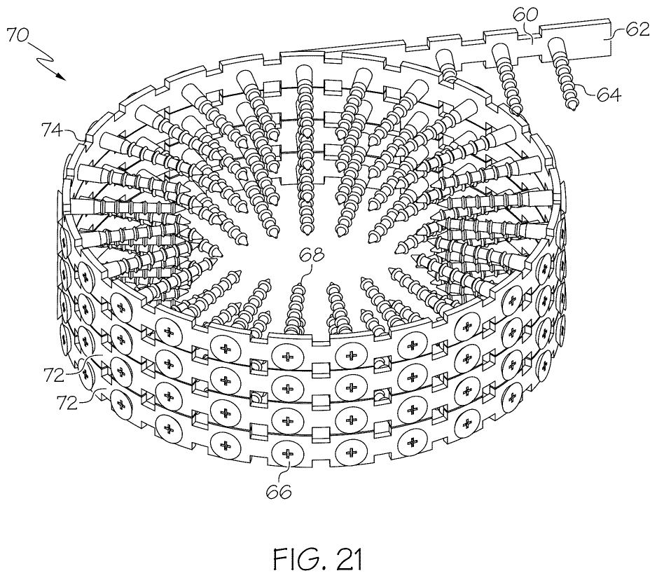

Referring now to the drawings, FIGS. 1-3 depict an autofeed fastener driving tool assembly (1) that includes an autofeed screwdriver tool (10), a tool mount assembly (100), a cartridge holder (200), a screw cartridge (70), a strip receptacle (402), and a receptacle support (500). The autofeed fastener driving tool assembly (1) is sometimes referred to as the “tool assembly”; and the autofeed screwdriver tool (10) is sometimes referred to herein as the “tool”; the cartridge holder (200) is sometimes referred to herein as an “attachment”. It should be noted that the screw cartridge (70) shows a screw strip (60) with an unrealistically large space between the screws (64) for purposes of clarity, and does not have a plurality of notches (74) (see FIG. 21) in the sides of the screw strip (60) that would be needed in a realistic screw strip to enable the screw strip (60) to engage the sprocket to index the screw strip (60) from one screw position to another screw position.

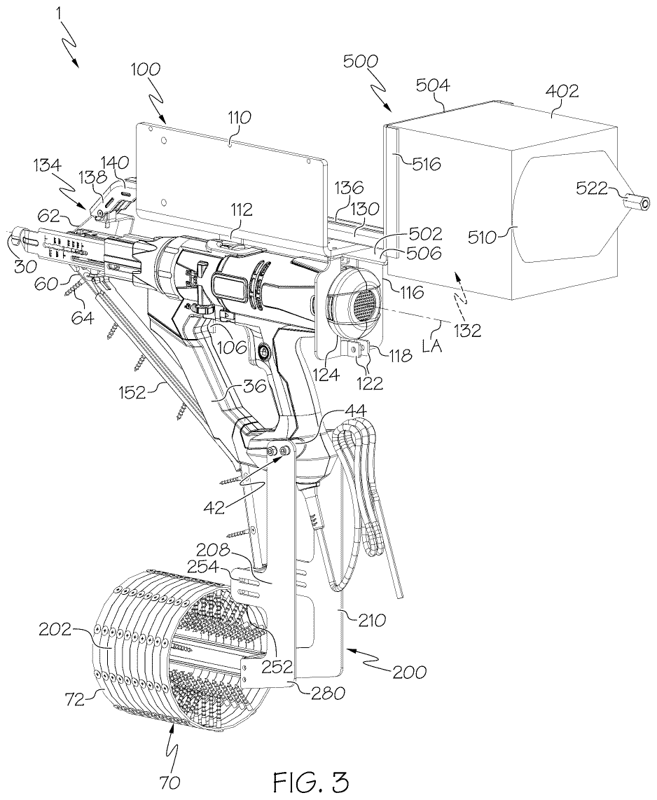

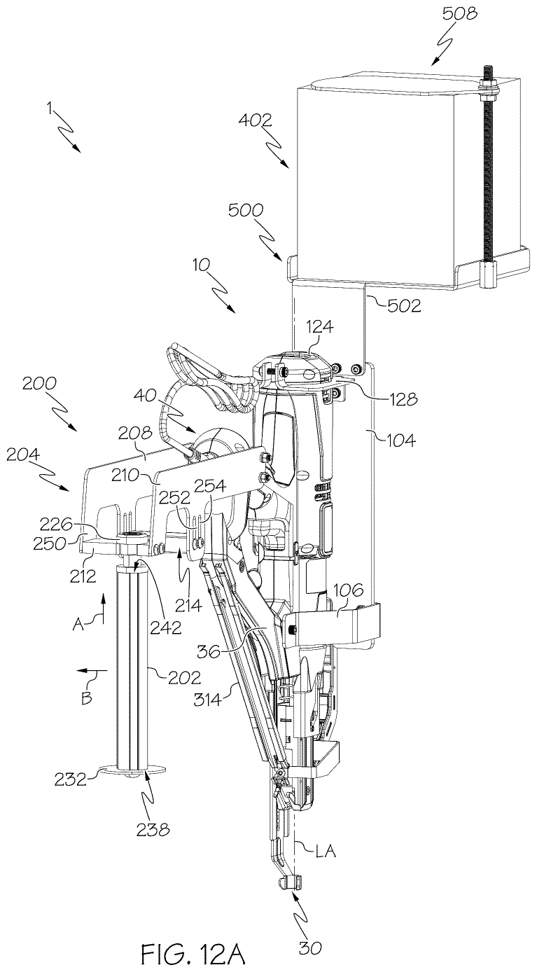

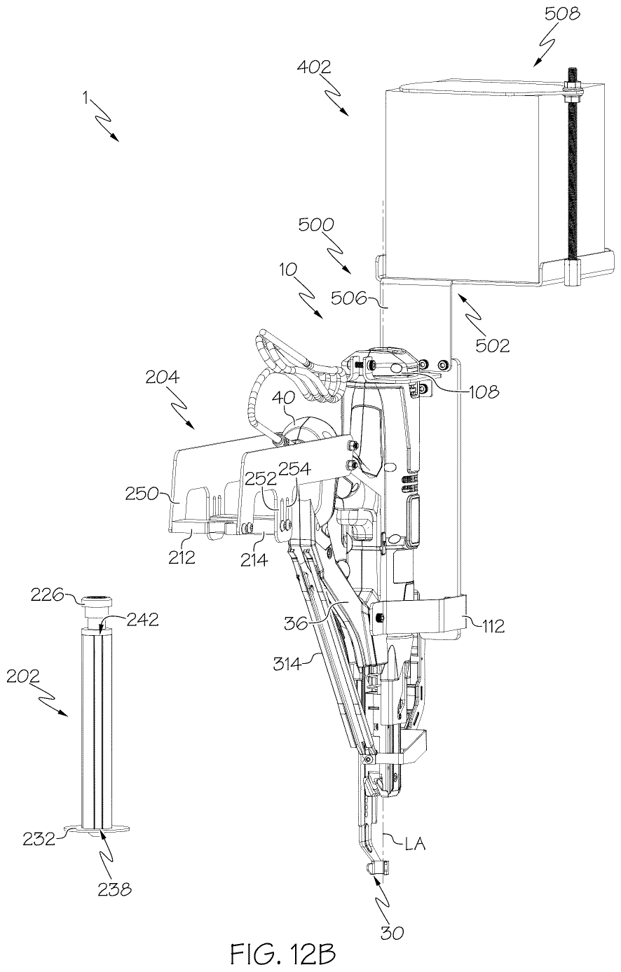

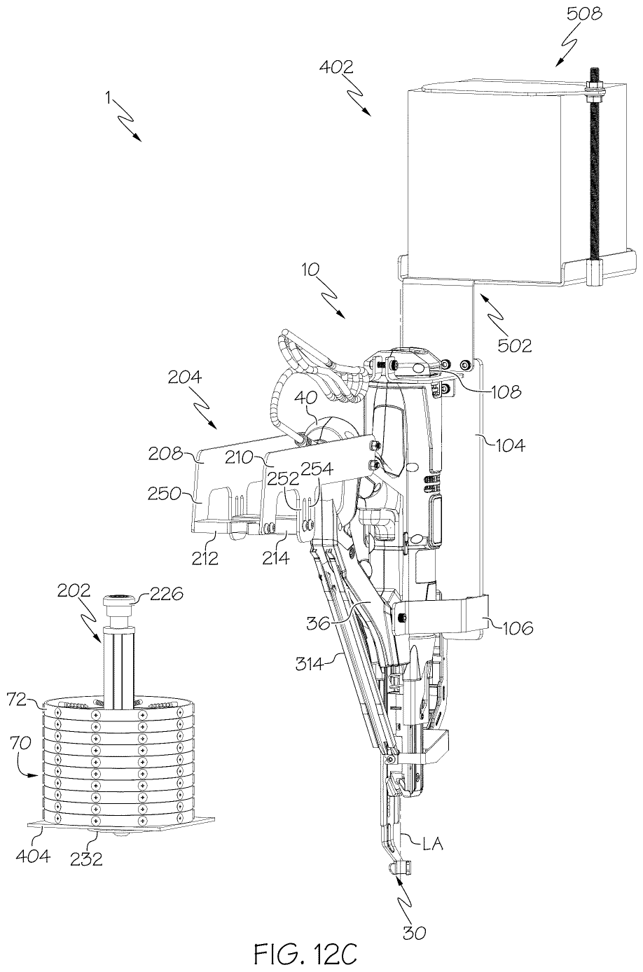

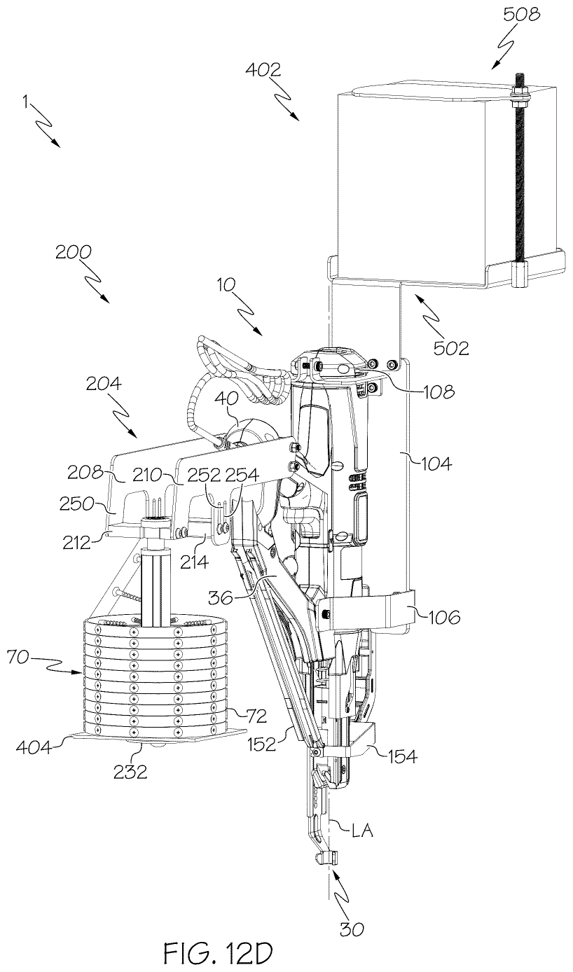

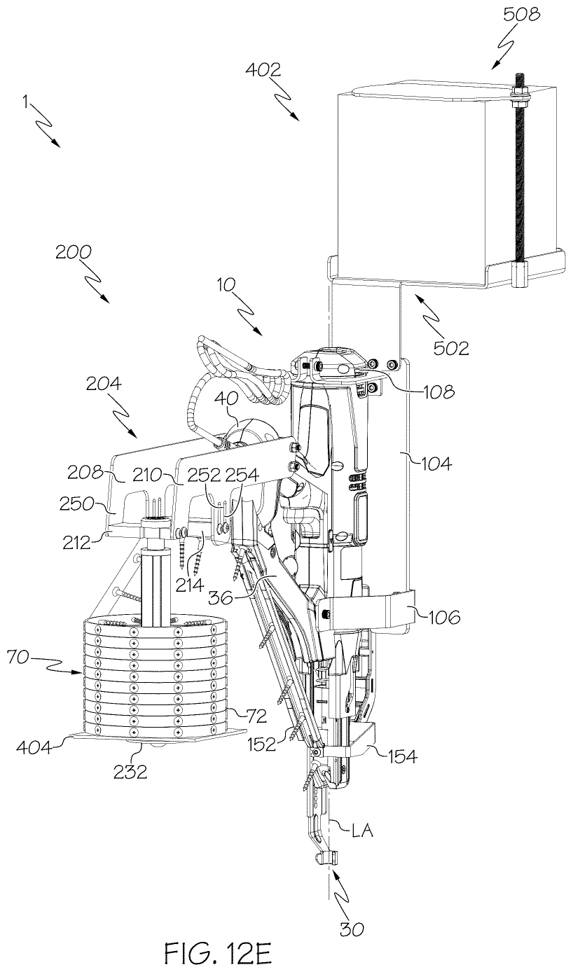

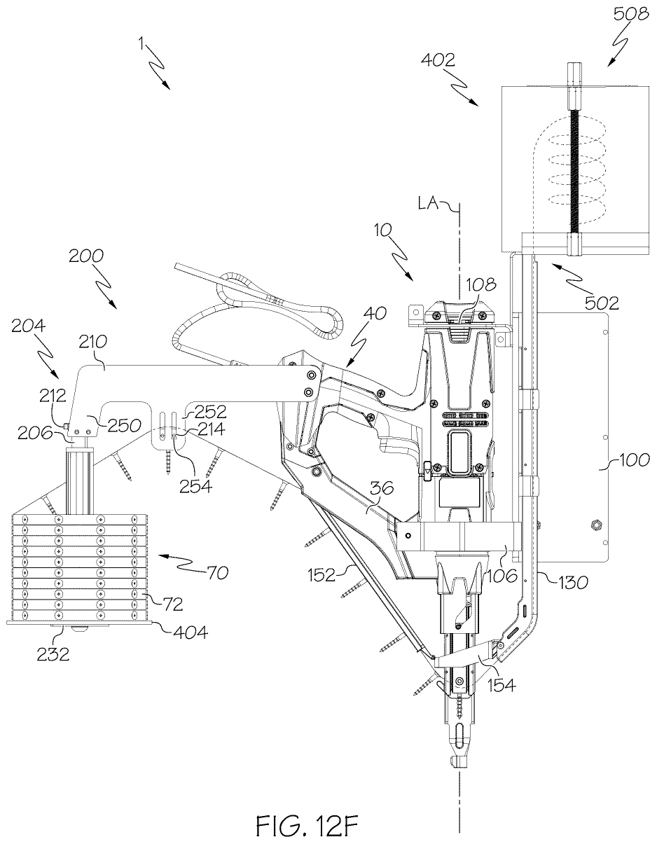

The autofeed fastener driving tool assembly (1) is configured to be removably coupled to an automated industrial machine (not shown) such as a robotic machine in a manufacturing setting. The autofeed fastener driving tool assembly (1) is shown in FIG. 1 in a horizontal orientation. The autofeed fastener driving tool assembly is positioned in a vertical orientation (see FIG. 12A-FIG. 12F) during use with the bottom of the tool facing the workpiece. In reference to FIG. 1 as illustrated the “front” of the tool assembly (1) is proximate to the top of the page; the “bottom” of the tool assembly (1) is the proximate to the right of the page; the “rear” or “back” of the tool assembly (1) is proximate to the bottom of the page; The portion of the tool assembly (1) proximate to the left of the page is the “top”; the portion of the tool assembly (1) that is viewed on the face of the page is the “right” of the tool assembly (1); and the portion of the tool assembly (1) that is hidden and cannot be viewed is the “left” (see FIG. 3) of the tool assembly (1).

The tool (10) is secured to such an automated industrial machine by the tool mount assembly (100). The tool (10) defines a longitudinal axis (“LA”) that extends from the top of the tool to a bottom end (30) of the tool (10). The tool mount assembly (100) includes a first mount panel (102), a second mount panel (104), first mount arms (106), and second mount arms (108). The tool mount assembly (100) is constructed of a rigid material such as steel or a hard plastic, for example. The first mount panel (102) defines a plurality of mounting bores (110) configured to receive fasteners (not shown) to mount the tool mount assembly (100) to an automated industrial machine (not shown) in a vertical orientation (see FIG. 12A-FIG. 12F). The first mount panel (102) is fixedly coupled to the second mount panel (104) with the long side of the panel extending parallel to the longitudinal axis (LA) and the short side of the second mount panel (104) being transverse to the longitudinal axis (LA). In the present embodiment, the first mount panel (102) and the second mount panel (104) are integrally formed from a single planar panel that is bent at a 90 degree angle. The second mount panel (104) extends parallel to a front of the tool (10). The second mount panel (104) is fixedly coupled to the first mounts arm (106) by fasteners or welding. The first mount arm (106) is positioned proximal to a bottom end (30) of the tool (10) and includes an elongate plate (112) that generally contours around the tool (10). the elongate plate (112) defines a first arm bore (114) positioned below the longitudinal axis (LA) of the tool (10). The first arm bore (114) transversely aligns with a threaded bore positioned within the tool (10) that is configured to receive a fastener (not shown) so that the elongate plate (112) is fastened to the tool (10).

In some versions, when the first mount arm (106) is fastened to a generic tool that is not configured to accept the first mount arm (106), the tool may be drilled to accept a fastener to fixedly locate the first mount arm (106) to the generic tool. In other versions, a pair of first mount arms (106) are positioned on two sides of the longitudinal axis (LA) of a generic tool and are fastened together around the tool (10). The pair of first mount arms (106) bend along their length and tighten around the tool (10) by the fastener that extends between a pair of first arm bores (114) so that the tool mount assembly (100) is fixedly positioned relative to the tool (10).

The second mount arms (108) include a pair of planar plates (116) that are transversely opposed relative to the pair of elongate plates (112) of the first mount arms (106). The second mount arms (108) are positioned proximal to the top of the tool (10). Each of the pair of planar plates (116) includes a tab (118) positioned below the tool (10) that extends 90 degrees from a bottom end (120) of each of the planar plates (116). Each tab (118) defines a second arm bore (122) configured to accept a fastener (not shown) therethrough. An inner radius (124) of each of the pair of planar plates (116) is defined by the outer surface of the tool (10). The fastener is configured to be tightened and this moves the inner radius (124) against the outer surface of the tool (10) and fixedly positions the tool mount assembly (100) to the tool (10).

A first strip guide (130) is mounted to the front of the tool mount assembly (100). The first strip guide (130) may also be referred to as the “front guide”. The first strip guide (130) is configured to move the “spent” plastic strip (62) away from the bottom end of the tool (10). The first strip guide (130) longitudinally extends from a distal end (132) at the top of the tool (10) to a proximal end (134) at the bottom of the tool (10). The distal end (132) of the first strip guide (130) is positioned within the strip receptacle (402) and the proximal end (134) is positioned proximate to the bottom end (30) of the tool (10). The first strip guide (130) includes a first portion (136) that extends parallel to the longitudinal axis (LA) of the tool (10) and second portion (138) that extends at an angle from the first portion (136) towards the bottom end (30) of the tool (10). The first and second portions (136, 138) consist of a pair of guide rails (140) that are operatively fastened together and extend parallel relative to one another. In some versions, the pair of guide rails may be integrally formed as one piece.

The first portion (136) is fixedly positioned above the second mount panel (104) by a pair of guide mounts (142). Each guide mount (142) includes a bottom plate (144) and a pair of arms (146) that wrap around the first portion (136). The bottom plate (144) is fixedly mounted to the second mount panel (104). The pair of arms (146) transversely extend from the bottom plate (144) to fixedly position the first portion (136) relative to the tool mount assembly (100). The second portion (138) is fixedly mounted to the tool (10) at a proximal end (134).

The receptacle support (500) is fixedly mounted to the rear of the second mount panel (104) by a plurality of fasteners (not shown) (see FIGS. 1-3). The receptacle support (500) is configured to hold the strip receptacle (402) that receives the “spent” plastic strip (62) from the first strip guide (130).

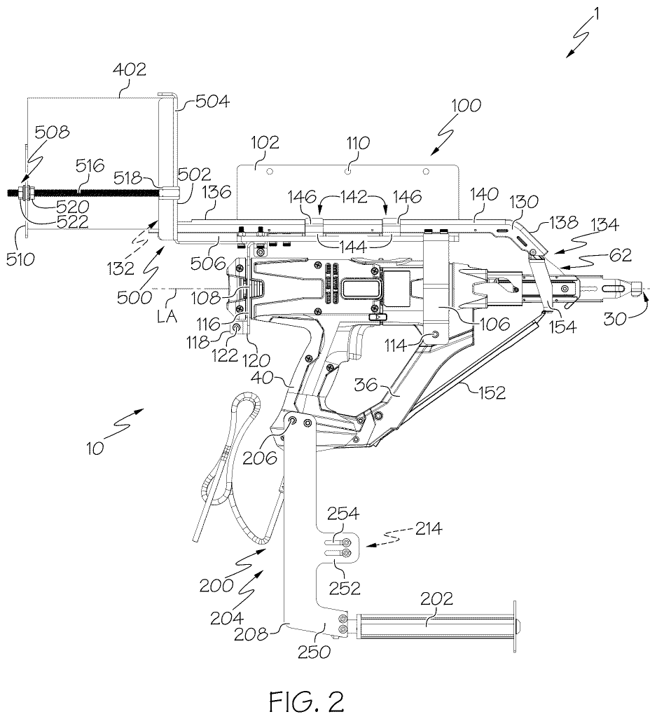

The cartridge holder (200) is shown in FIGS. 1 and 3 loaded with the screw cartridge (70). FIG. 2 shows the cartridge holder (200) without being loaded with the screw cartridge (70).

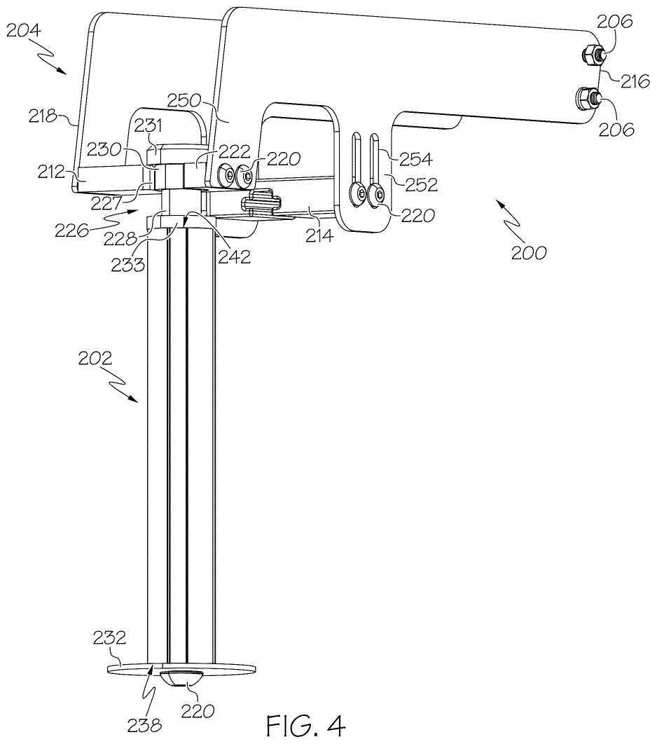

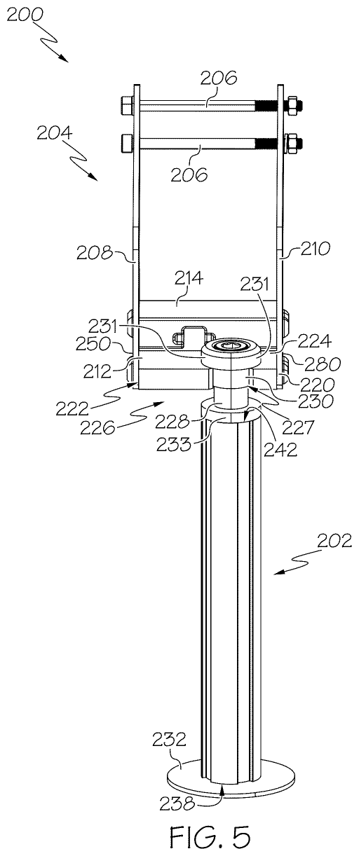

FIGS. 4-6 best show the cartridge holder (200) comprising a spool (202) and a spool support (204). The spool support (204) is fixedly mounted to the handle (40) of the tool (10) (see FIGS. 1-3) with at least one fastener (206). In the present version, two fasteners (206) are bolted through the spool support (204). Each of the two fasteners (206) extend through the handle (40) of the tool (10) (see FIG. 1). The handle (40) of the tool (10) may also be configured to accept such an attachment. In such versions, the handle (40) may include a pair of facets (42) configured to allow the spool support (204) to sit flush against the handle (40) (see FIG. 1). The facets (42) may also include a boss (44) that has a larger cross sectional area (see FIG. 1). The boss (44) is configured to provide additional engagement of the facet with the spool support (204) so that the spool support (204) is sufficiently supported (see FIG. 1). In other versions, two holes may be drilled through a handle of an existing tool to retrofit the existing tool to support the cartridge holder (200). When retrofitted to the existing tool, there may be additional hardware and brackets to help affix the cartridge holder (200) to the tool.

The spool support (204) comprises a first panel (208), a second panel (210), a spool hanger (212), and a second strip guide (214). The spool support (204) is constructed of a lightweight material such as aluminum or plastic. The first and second panels (208, 210) extend transversely from the handle (40) and are parallel to one another. The first and second panels (208, 210) are spaced apart by a distance that is defined by the width of the pair of facets (42). The first and second panels (208, 210) are planar and extend towards the rear of the tool (10) from the first end (216) to a second end (218). It should be noted that the first and second panels (208, 2010) are not required to be planar but is merely an example of a way to support the spool hanger (212) and the second strip guide (214).

In the present embodiment, the spool hanger (212) is fixedly coupled between the first and second panels (208, 210) by a plurality of hanger bores (220) that extend through a pair of first portions (250) of the first and second panels (208, 210) (see FIGS. 4-6). The first portion (250) obliquely extends from the bottom of each of the first and second panels (208, 210) proximal to second end (218). The first portion (250) is configured to support the spool hanger (212). The spool hanger (212) defines threaded bores (222) that align with bores in the each of the first portions (250). The spool hanger (212) includes a circular aperture (224) and a notch (227) that are configured to accept the spool (202). The notch (227) includes a notch width that is smaller relative to a dimeter of the circular aperture (224).

Each of the first and second panels (208, 210) include a second portion (252) that is positioned between the first and second ends (216, 218). The second portion (252) extends obliquely from a medial portion of each of the first and second panels (208, 210). The second portion (252) includes a pair of slots (254) that vertically extend. The second strip guide (214) may further be referred to as a rear support guide. A pair of fasteners (220) extend through the slots (254) to fasten the second strip guide (214) to the second portion (252). The slots (254) allow the screw strip (60) to be vertically positioned at different heights so that the screw strip (60) may be guided from the screw cartridge (70) to the bottom strip guide (36) and further to a third strip guide (152). The third strip guide (152) may be further referred to as a bottom attachment guide. The third strip guide (152) guides the screw strip (60) to the bottom end (30) of the tool (10). The second strip guide (214) defines a cutaway that is similarly shaped to the screw strip (60) that rotationally aligns the screw strip (60) with the bottom strip guide (36). The bottom strip guide (36) supports a bottom portion of a third screw guide (152). The third screw guide (152) is supported by a tension support (154). The tension support (154) is fixedly coupled to the first strip guide (130). The third screw guide (152) in present embodiment bypasses the bottom strip guide (36) that guides the screw strip (60) to the bottom end of the tool (10) when the tool (10) is not fitted with the cartridge holder (200). In some embodiments the third screw guide (152) will not be fitted to the tool and the bottom strip guide (36) will be used to guide the screw strip (60) to the bottom of the tool

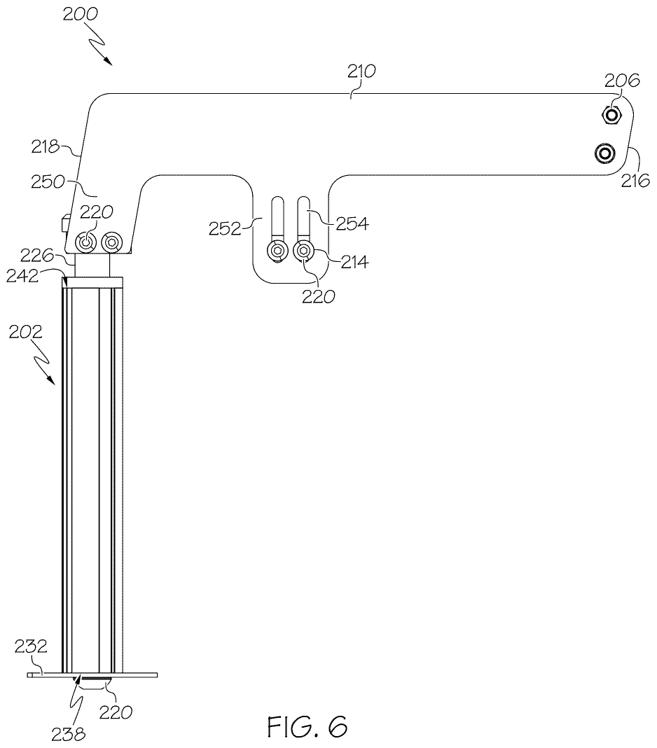

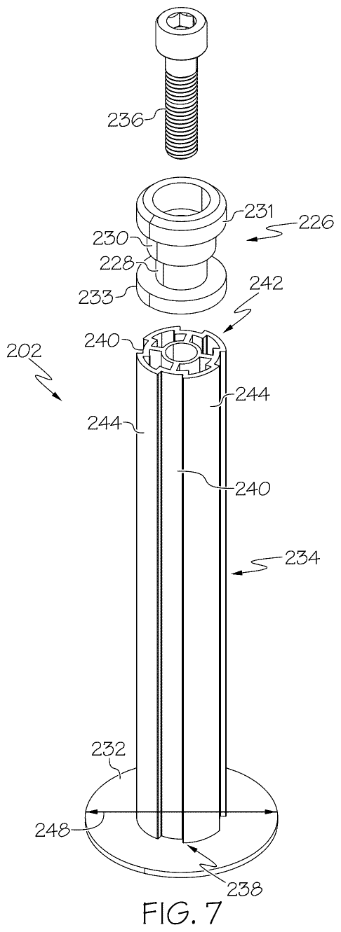

Referring now to FIG. 7, the spool (202) including a retainer (232), an elongate shaft (234), a hub (226) and a hub fastener (236) are illustrated. The retainer (232) is fixedly coupled to a first end (238) of the elongate shaft (234). The elongate shaft (234) may be integrally formed with the retainer (232) or the retainer (232) may be fastened to the elongate shaft (234) by one or more fasteners (see FIG. 6). The elongate shaft (234) and the retainer (232) are formed of a rigid material such as extruded aluminum, for example. The hub (226) is formed of a different rigid material such as plastic, for example. In some versions, the hub and elongate shaft (234) may be formed of the same rigid material, for example. The retainer (232) has a retainer width (248) that is sized to interact with the cartridge container (400) to remove the screw cartridge (70).

The elongate shaft (234) extends from a first end (238) to a second end (242). The elongate shaft (234) includes a plurality of protrusions (244) and a plurality of recesses (240) extend along the length of the elongate shaft (234). In the present embodiment, the elongate shaft (234) includes four protrusions (244) and four recesses (240), but may include any number of protrusions and recesses (240) needed to interact with the screw cartridge (70) to rotate the cartridge holder (200) during use. The hub (226) is coupled to a second end (242) of the elongate shaft (234) by the hub fastener (236). The hub (226) is configured to rotates relative to the elongate shaft (234). The hub (226) is constructed of different materials than spool hanger (212). The selection of materials of the hub (226) and spool hanger (212) helps maintain a predetermined a coefficient of friction between the hub (226) and the spool hanger (212). This friction helps the screw strips (60) to remain taught without becoming too tight when fed into the autofeed screwdriver tool (10). IN some versions, the hub (226) and/or spool hanger (212) may include surface effects to set this predetermined friction, for example these surface effects may include polishing, knurling, or roughening of the engagement surfaces, for example. The hub (226) is fixed relative to the elongate shaft (234) by the hub fastener (236).

The hub (226) will be configured to create a predetermined amount of friction to prevent rotation of the spool (202) relative to the tool (10). The hub (226) is circular in shape and includes a first hub diameter (228), a second hub diameter (230), a third hub diameter (231), and a fourth hub diameter (233). The first hub diameter (228) is vertically placed above the fourth hub diameter (233); The second hub diameter (230) is vertically positioned above the first hub diameter (228); and the third hub diameter (231) is vertically positioned above the second hub diameter (230). The notch (227) (see FIGS. 4-6) includes a notch width that is slightly larger than a first hub diameter (228) so that the first hub diameter (228) may be passed through the notch (227). The second hub diameter (230) is configured to fit within the circular aperture (224). The second hub diameter (230) and the circular aperture (224) are sized fit together with a predetermined amount of friction to keep the screw strip (60) taut when being removed from the screw cartridge (70). Once the spool (202) is placed within the spool hanger (212), the spool (202) will remain affixed to within the spool hanger (212) by gravity. The third hub diameter (231) may also be sized to create a particular amount of resistance to rotation as the third hub diameter (231) rotates upon a top surface of the spool hanger (212). The third hub diameter (231) is sized larger than the circular aperture (224) to retain the spool (202) within the spool hanger (212) by gravity. The fourth hub diameter (233) is sized similarly to the outer diameter of the elongate shaft (234).

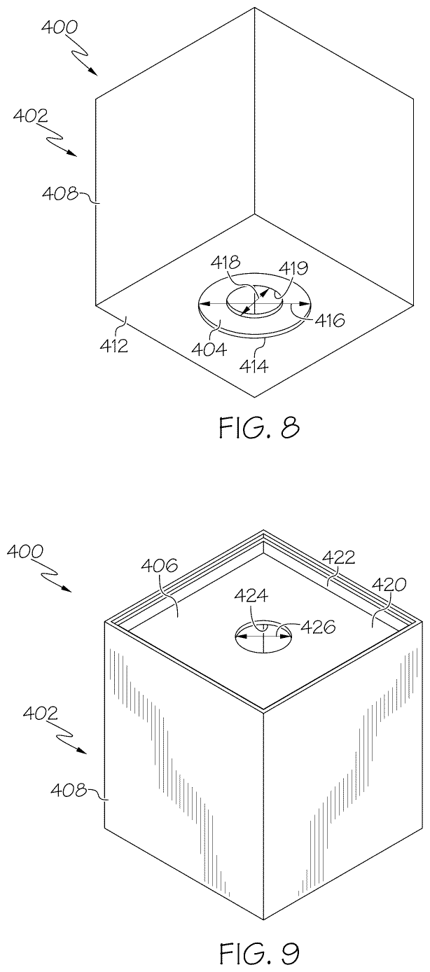

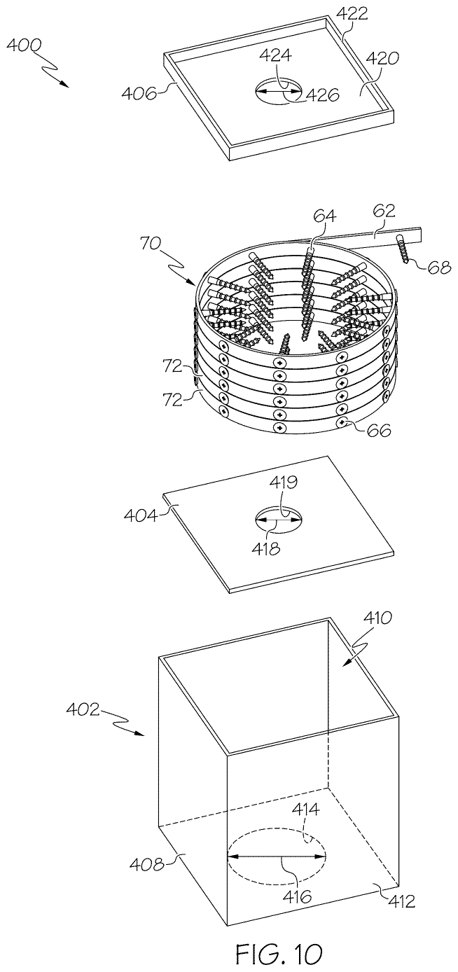

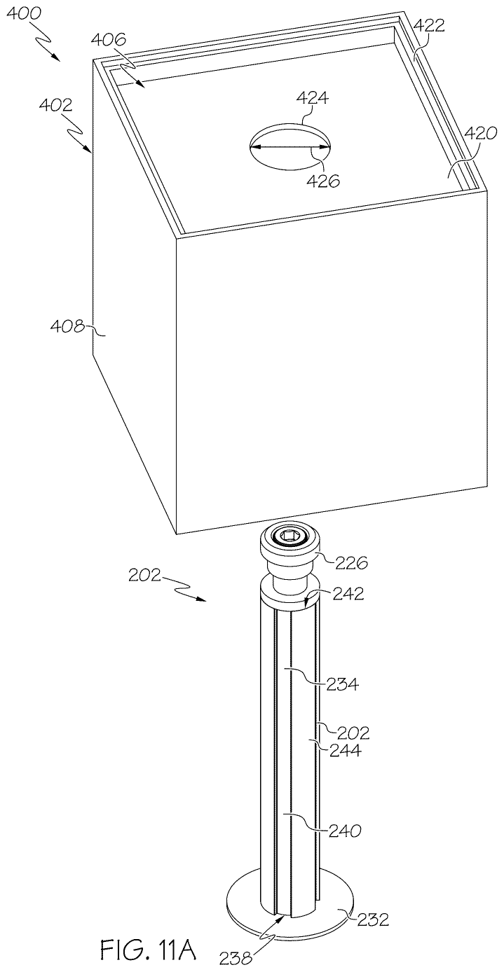

FIGS. 8-10 best show the cartridge container (400). The cartridge container (400) is used to ship the screw cartridge (70)). The cartridge container (400) is constructed of an inexpensive, rigid material such as cardboard, for example. Such an inexpensive material is disposable after use. The cartridge container (400) includes a strip receptacle (402), an insert (404), the screw cartridge (70), and a lid (406). It should be noted that an additional cover (not shown) may be fitted to the strip receptacle (402) during shipping to prevent debris from entering the container.

The strip receptacle (402) is in the form of an exterior housing of a box. The strip receptacle (402) includes at least one side panel (408), an open top (410), and a base panel (412). The base panel (412) and the at least one side panel (408) define an interior space. In the present embodiment, there are four side panels (408). The base panel (412) includes a centrally located base aperture (414) having a base diameter (416) that is slightly larger relative than the retainer width (248).

The insert (404) includes a planar surface that defines a centrally located insert aperture (419) having an insert diameter (418). The insert (404) includes a width that compliments the inner width of the collective side panels (408). The insert (404) may include a rectangular shape or a circular shape, for example. The insert diameter (418) is sized smaller relative to the base diameter (416) and the protrusions (244). The insert diameter (418) is sized larger than the protrusions (244), and the fourth hub diameter (233). The insert aperture (419) is sized to allow the protrusions (244) to pass through the insert aperture (419) with without engaging the protrusions (244) which allows the spool (202) to move in a rotational manner relative to the insert (404). The insert (404) is positioned within at the bottom of an interior of the strip receptacle (402).

A screw cartridge (70) is placed above the insert (404) within the strip receptacle (402) and below the lid (404). The screw cartridge (70) comprises a screw strip (60) including a plastic strip (62) that has a plurality of openings configured to retain individual screws (64). These openings are spaced apart at a set distance from one another that corresponds with a distance needed to feed the screw strip (60) into the tool for use. The screws (64) are placed within the plastic strip (62) in a coiled arrangement with a head (66) of each screw (64) positioned within each of the openings of the plastic strip (62). This coiled arrangement includes a plurality of wraps (72) that extend around the circumference of the screw cartridge (70). This coiled arrangement may be in a generally helical or spiral shape. A wrap (72) is defined as a portion of the screw strip (60) that extends around the circumference of the screw cartridge (70). All of the wraps are generally aligned relative to one another with the upper portion of a lower wrap (72) engaging a lower portion of an upper wrap (72) by the force of gravity. In other embodiments, the wraps (72) may be nested within one another to reduce the overall height of the screw cartridge (70). Each screw tip (68) is distally positioned relative to the plastic strip (62). The screw cartridge (70) is loosely positioned within the cartridge container (400) with each screw tip (68) facing inwards. The screw cartridge (70) does not have any structure that align the screw strip (60) in the coiled arrangement, but may be formed in a manner that creates the coiled configuration. The plastic strip (62) forms an outer diameter of the screw cartridge (70) and the screw tips (68) form the inner diameter of the screw cartridge (70). The tips (68) unlike the heads (66) are not rigidly positioned within the plastic strip (62) relative to one another which allow the screw strip (60) to be coiled together with an inner diameter that is relatively smaller than a coil of screws having an inner diameter that is formed by a plastic strip. The screw tips (68) in at least one wrap (72) are positioned above other screw tips (68) in another adjacent wrap (72). This positioning of the screw tips (68) that faces inwards enables the outside diameter to be reduced relative to an arrangement with the screw tips (68) facing outwards. The overall height of the screw cartridge (70) may also be reduced by nesting a wrap (72) of the screw cartridge (7) within another wrap (72).

The screw tips (68) are also facing inwards to prevent the screw tips (68) from snagging on the cartridge container (400) or poking users when the screw cartridge (70) is removed from the cartridge container (400). The screw strip (60) is flexible to a certain degree, as can be seen in the drawings by the curved orientation when the screw strip (60) is coiled as a screw cartridge (70) but also is fed into the tool (10) by various guides.

The inner diameter of the screw tips (68) is greater than the insert aperture (419) so that the spool (202) easily passes through the screw cartridge (70). The inner diameter of the screw tips (68) is sized so that the protrusions (244) engage the screw tips (68). The engagement between the screw tips (68) and the protrusions (244) prevents the screw cartridge (70) from unraveling from the spool (202). In other embodiments, the inner diameter of the screw tips (68) is less than the diameter of the elongate shaft (234) and the screw tips (68) deflect to allow the spool to pass through the screw cartridge (70). Having an inner diameter of screw tips (68) than the diameter of the elongate shaft (234) provides the advantage of a smaller overall outer diameter of the screw cartridge (70).

The lid (406) includes a shape that fits within the cartridge container (400). The lid (406) includes a central lid panel (420), and lid side panels (422). In the current version the cartridge container (400) includes four lid side panels (422) which surround the central lid panel (420) and forms a rectangular shape. In other versions, the side panels may create different shapes, for example: circular, triangular, or octagonal. The central lid panel (420) defines a centrally located lid aperture (424) having a lid aperture diameter (426). The lid aperture diameter (426) is sized slightly larger than the fourth hub diameter (233) and the protrusions (244). The lid aperture (424) is sized slightly larger than the protrusions (244) so the spool (202) may be aligned by the lid aperture (424) but does not frictionally engage the lid (406). This fit facilitates easy removal of the lid (406) after the spool (202) is inserted within the cartridge container (400), while also aligning the spool (202) within the cartridge container (400).

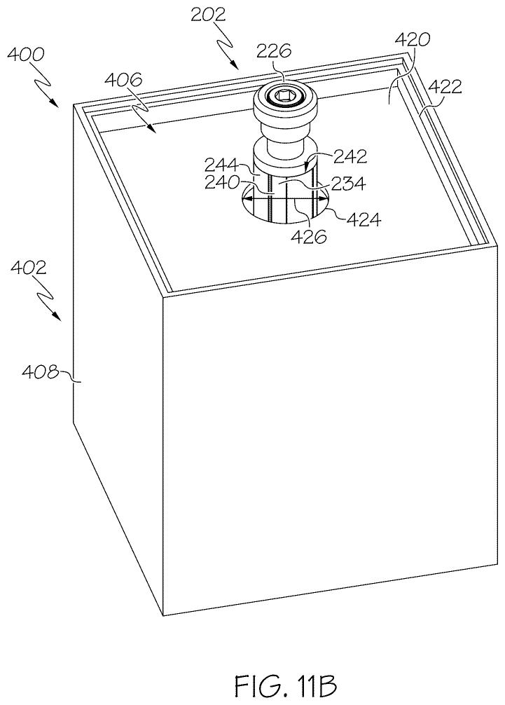

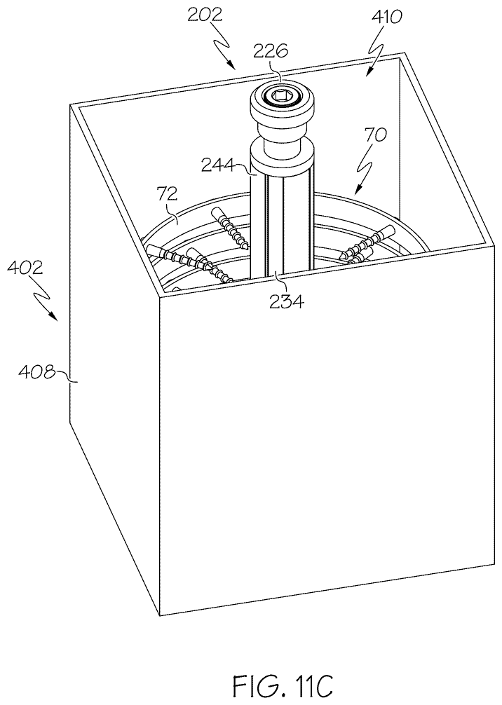

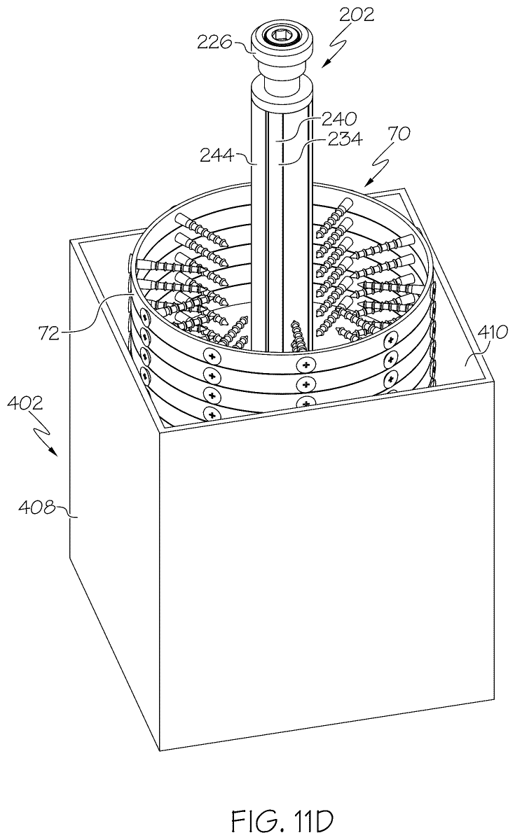

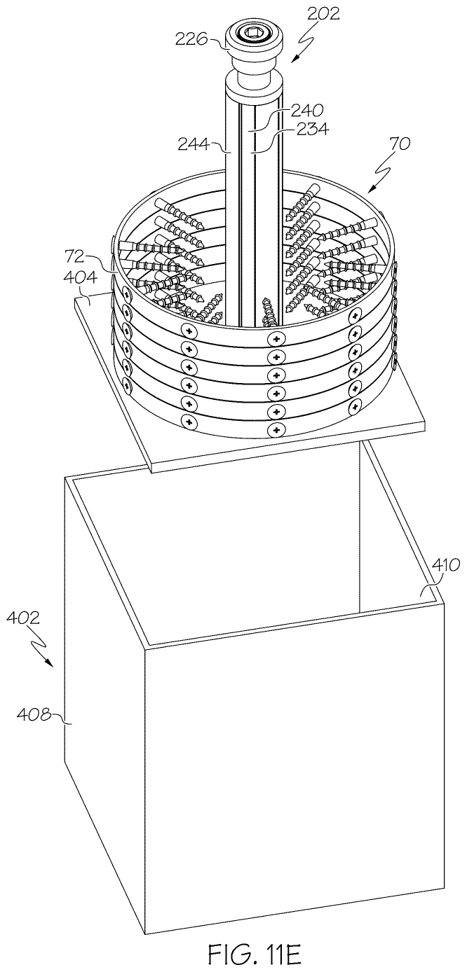

FIGS. 11A-11E illustrate the spool (202) being used to remove the screw cartridge (70) from the cartridge container (400). FIG. 11A shows the spool before being inserted through a bottom side of the cartridge container (400). The hub (226) may be removed from the spool (202), so that the hub (226) does not interfere with the screw cartridge (70) loading process. However, in the present embodiment, the hub (226) remains tightly secured to the spool (202) while the spool (202) is passed through the cartridge container (400). The hub (226) is first passed through the base aperture (414) and further through the insert aperture (419).

FIG. 11B shows the spool (202) being further inserted until the retainer (232) engages the bottom portion of the insert (404), and the hub (226) further is inserted through the lid (406) and beyond the top of the strip receptacle (402). The spool (202) additionally has been passed through the screw cartridge (70).

FIG. 11C shows the cartridge container (400) without the lid (i.e., a human user removed the lid). In FIG. 11C, the retainer (232) has partially passed through the base aperture (414) and the retainer (232) engages a bottom surface of the insert (404). The screw cartridge (70) rests upon a top surface of the insert (404).

FIG. 11D shows the screw cartridge (70) being partially removed from the cartridge container (400) by moving the spool (202) in a direction towards the hub (226); again, this action would be performed by a human user. The retainer (232) fully passes through the base aperture (414), and engages the bottom surface of the insert (404). The top surface of the insert (404) engages a bottom portion of the screw cartridge (70) and lifts the screw cartridge (70) from the strip receptacle (402).

FIG. 11E shows the spool (202) and screw cartridge (70) after the spool (202) captures the screw cartridge (70) and the screw cartridge (70) has been fully removed from the strip receptacle (402). The spool (202) and screw cartridge (70) are ready to be installed within the cartridge holder (200) to supply screws (64) to the tool (10). The strip receptacle (402) has been separated from the remains of the cartridge container (400) and is ready to be installed within the receptacle support (500).

FIGS. 12A-12F shows the process of loading the screw cartridge (70) into the autofeed screwdriver assembly (1). FIG. 12A shows the autofeed screwdriver assembly (1) with an empty cartridge holder (200). In order to load the autofeed screwdriver assembly (1) with screws (64), The spool (202) must be removed from the spool support (204). This is accomplished by moving the spool (202) vertically (see arrow A of FIG. 12) so that the first hub diameter (228) is transversely aligned with the notch (227). Aligning the first hub diameter (228) of the hub (226) with the notch (227) allows the spool to be moved horizontally (see arrow A of FIG. 12) away from the spool hanger (212) because the first hub diameter (228) is smaller than the notch (227).

FIG. 12B shows the spool (202) separate and apart the spool hanger (212) after being removed. The spool (202) may now be loaded with the screw cartridge (70) with the procedure detailed in FIGS. 11A-11E.

FIG. 12C shows the spool (202) after being loaded with the screw cartridge (70) by the procedure detailed in FIGS. 11A-11E. The spool (202) and screw cartridge (70) are loaded within the spool hanger (212) in a manner that is the reverse of the removal of the spool (202) (see FIG. 12A). The first hub diameter (228) is aligned with the notch (227) and the spool (202) is moved horizontally through the notch (227). The second hub diameter (230) is concentrically aligned within the circular bore (224) and the user releases the spool (202) allowing the spool (202) to fall by gravity. The second hub diameter (230) falls within the circular bore (224). The third hub diameter (231) being larger relative to the circular bore (224) engages a top surface of the spool hanger (212) holding the spool (202) within the spool hanger (212).

FIG. 12D shows the screw strip (60) being loaded into the autofeed screwdriver tool (10). Once the spool (202) is positioned within the spool hanger (212), a first end of the screw strip (60) is aligned with and moved through a cutaway defined by the second strip guide (214). The screw strip (60) is removed from the screw cartridge (70) with the screws (64) oriented horizontally. The screw strip (60) must be rotated to go through the cutaway of the second strip guide (214) which changes the orientation of the screws (64) to a vertical orientation. The screw strip (60) is further fed through a portion of the bottom strip guide (36) and further through the third strip guide (152) to the bottom end (30). The second strip guide (214) is configured to be raised and lowered within the slots (254) and then the fasteners (22) lock the second strip guide (214) in place. The location of the second strip guide (214) depends upon the location of the bottom guide rail (32) of the particular autofeed screwdriver tool (10) relative to the location of the spool (202). In some embodiments, the second strip guide (214) is loosely fitted to the second portions (252) so that that the second strip guide (214) may move throughout the range of the slots (254).

FIG. 12E shows the screw strip (60) being fed further through the bottom strip guide (36) after screws (64) have been fastened into a workpiece by the autofeed screwdriver tool (10). The screw strip (60) further is providing the autofeed screwdriver tool (10) additional screws (64) that are placed in alignment with the driving rod (not shown). After the screws (64) are fastened into the workpiece, the “spent” plastic strip (62) is further fed into the first strip guide (130).

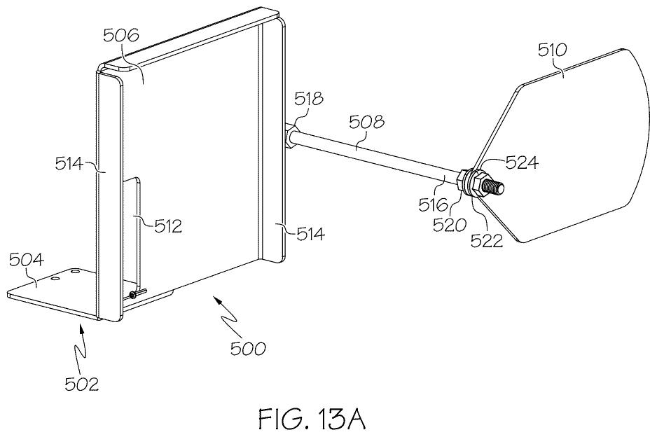

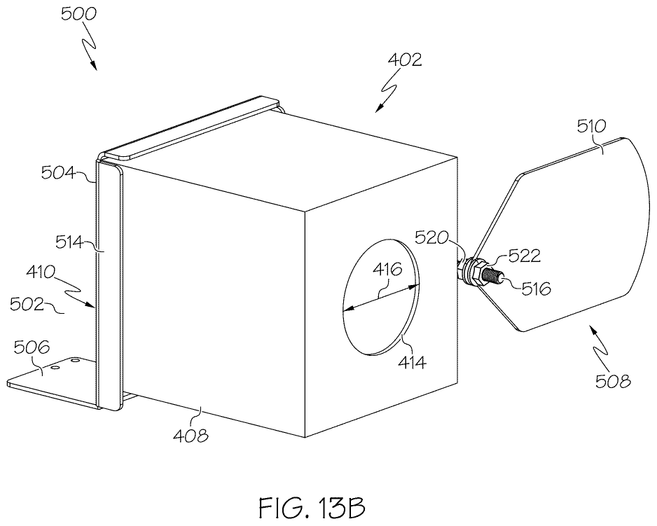

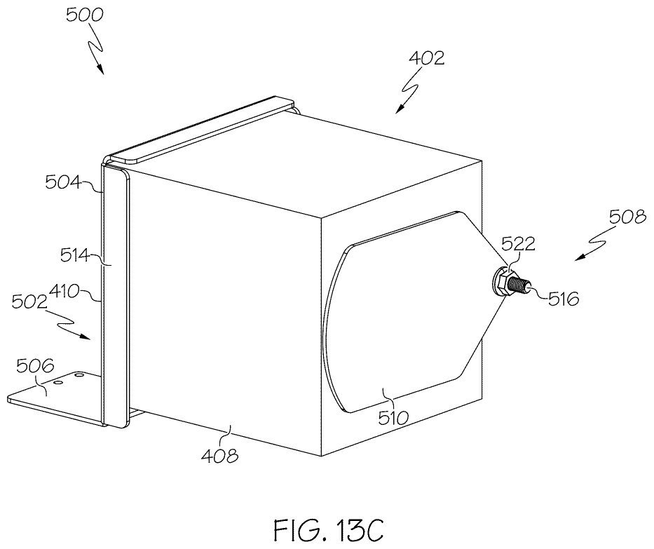

Referring to FIG. 12F, the plastic strip (62) is shown being fed yet further along the first strip guide (130) and is being deposited into the strip receptacle (402). This strip receptacle is a portion of the original cartridge container (400) that was used to ship the screw cartridge (70) to the end user. Once all of the screws have been fired, the plastic strip (62) are fed into the strip receptacle (402). A user manually feed the remaining portions of the plastic strip (62) that remain in the first strip guide (130) into the strip receptacle (402). Once the plastic strip (62) is fully in the strip receptacle (402), the user is able to properly dispose of both the plastic strip (62) and the strip receptacle (402). The strip receptacle (402) is removed from the tool (10) by the reverse of the procedure outlined in FIGS. 13A-13C. The strip receptacle (402) containing the plastic strip (62) as one package are deposited into the trash.

Referring now to FIGS. 13A-15, the empty receptacle support (500) may be loaded with the strip receptacle (402) to retain the “spent” plastic strip (62) after the screws (64) have been screwed into the workpiece. The receptacle support (500) includes a bracket (502) having a mounting plate (504), a securing plate (506), a rotatable coupling (508), and a rear plate (510) (see FIG. 13A). The mounting plate (504) is integrally formed with the securing plate (506) from a rigid material such as metal or hard plastic, for example.

The mounting plate (504) extends parallel to the second mount panel (104). The securing plate (506) extends transversely from the mounting plate (504). The mounting plate (504) and securing plate (506) may be integrally formed with one another or may be separate parts assembled with fasteners (not shown). The securing plate (506) defines a rectangular cutaway (512), a first pair of side plates (514). The securing plate (506) optionally may include a second pair of side plates (526). The rectangular cutaway (512) is configured to accept the first strip guide (130) therethrough. The first pair of side plates (514) are configured to transversely locate the strip receptacle (402) in a first direction within the receptacle support (500) and the second pair of plates (526) transversely locate the strip receptacle (402) in a second direction. The rotatable coupling (508) is operatively coupled to the securing plate (506) and includes a threaded rod (516) and a plurality of female fasteners (518, 520, 522). A first female fastener (518) of the plurality of female fasteners (518, 520, 522) is fixedly coupled to the securing plate (506) by welding. The threaded rod (516) is threaded into the first female fastener (518) and extends distally away from the securing plate (506). A second and a third female fastener (520, 522) are distally located relative to the first female fastener (518).

The rear plate (510) includes a planar configuration and defines a plate bore (524). The plate bore (524) is sized large enough to allow the threaded rod (516) to pass through the plate bore (524) but is small enough to engage the second and third female fasteners (520, 522). The second and third female fasteners (520, 522) are tightened on opposite sides of the plate bore (524) to locate the rear plate (510) upon the threaded rod (516). This configuration allows the rear plate (510) to rotate relative to the securing plate (506). FIG. 13A shows the threaded rod (516) that secures the rear plate (510) is rotated to an open position (as shown) to accept an empty strip receptacle (402). In the open position, the strip receptacle (402) is provided a clear path to be secured into the receptacle support (500).

Referring now to FIG. 13B, the strip receptacle (402) is positioned between the pair of the side plates (514) with the open top (410) of the strip receptacle (402) facing the securing plate (506), and the rectangular cutaway (512) so that the first strip guide (130) extends into the open top (410). The distal end (132) of the first stirp guide (130) being within the strip receptacle (402) allows the plastic strip (62) to be fed into the box without kinking. The bottom of the strip receptacle (402) faces towards the top of the autofeed screwdriver assembly (1). The rotatable coupling (508) is shown still in the open position.

Referring now to FIG. 13C, the rear plate (510) is illustrated after being rotated to the closed position. In the closed position, the rear plate (510) covers the base aperture (414). The rear plate (510) is wider relative to the base aperture (414) to prevent the plastic strip (62) from exiting the strip receptacle (402). The rear plate (510) also secures the strip receptacle (402) within the receptacle support (500). The threaded rod (516) may be rotated more than 360 degrees until the rear plate (510) engages the strip receptacle (402) so that the strip receptacle (402) is held within the receptacle support (500). The pitch of the threads of the threaded rod (516) determines how quickly the rear plate (510) tightens against the strip receptacle (402).

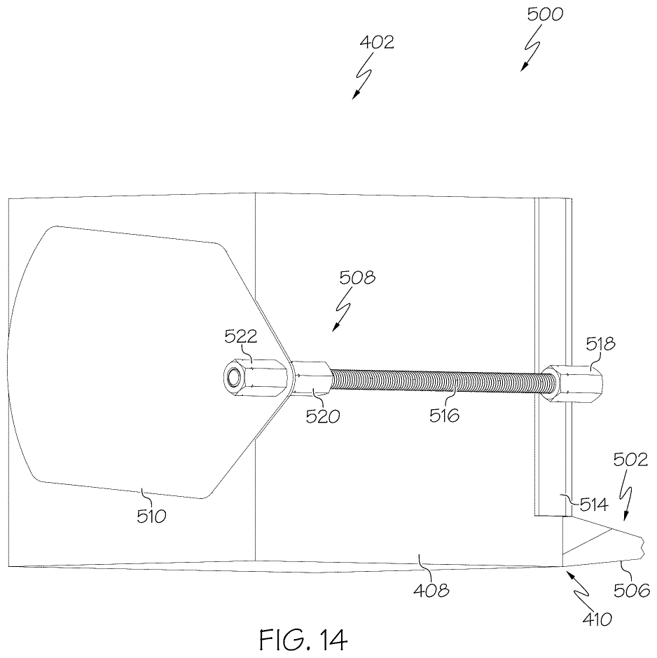

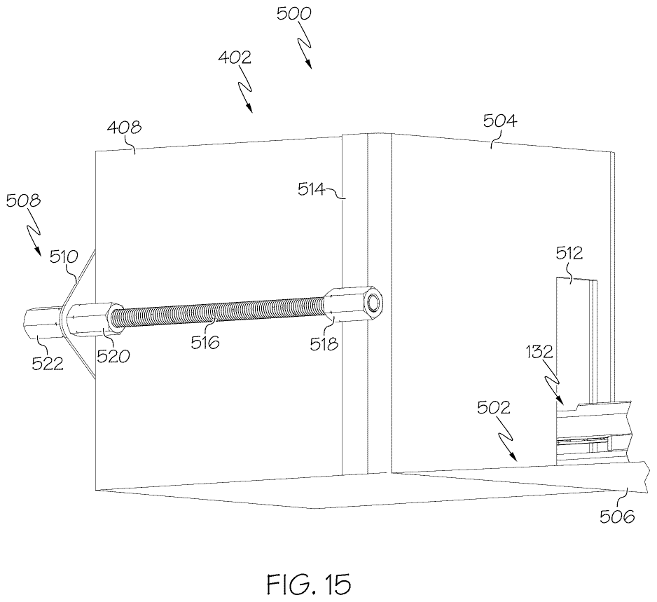

FIGS. 14 and 15 depict the strip receptacle (402) shown from different angles after the strip receptacle (402) is secured within the receptacle support (500), with the rear plate (510) in the closed position.

### First Alternative Embodiment

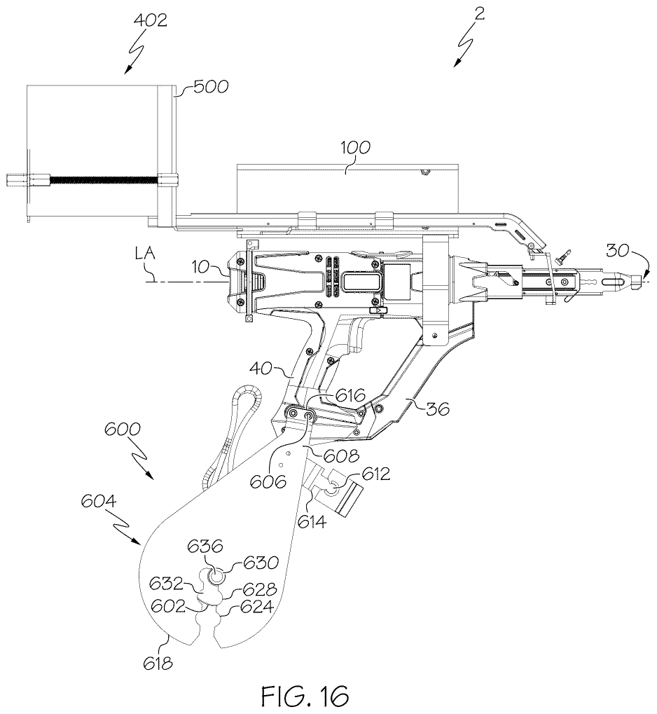

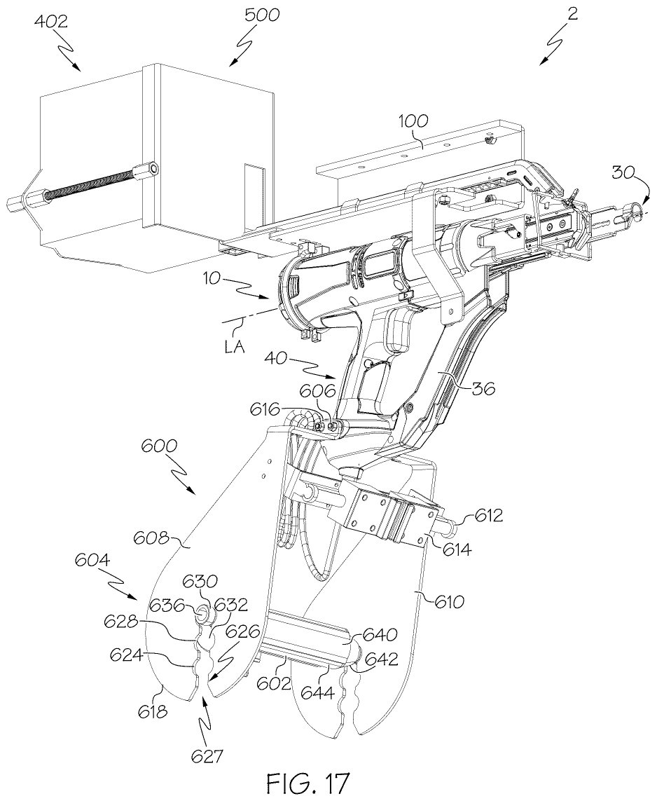

Referring now to FIGS. 16-17, a first alternative embodiment of an autofeed screwdriver assembly is generally depicted at reference numeral 2. The autofeed screwdriver assembly of FIGS. 16-17 includes an autofeed screwdriver tool (10), a cartridge holder (600), a strip receptacle (402), a tool mount assembly (100) and a receptacle support (500). Both the autofeed screwdriver assembly (1) and the first alternative embodiment autofeed screwdriver assembly (2) is configured to use a similar screw cartridge (70) that includes a plastic strip (62) that includes screws (64) having screw tips (68) oriented towards the spool (602). The autofeed screwdriver assembly (2) includes similar structure and functions similarly to the autofeed screwdriver assembly (1). However, the first alternative embodiment autofeed screwdriver assembly (2) differs from the autofeed screwdriver assembly (1) in that the first alternative embodiment autofeed screwdriver assembly (2) includes a cartridge holder (600) that holds the screw cartridge (70) is a position that is transverse to a longitudinal axis (LA) of the tool (2). In operation, the autofeed screwdriver assembly (2) must be oriented so that the longitudinal axis (LA) is oriented with the bottom end (30) of the tool above the workpiece in a vertical orientation similar to the autofeed screwdriver assembly (1) (see FIGS. 12A-12F). This vertical orientation is in contrast to the horizontal orientation as shown in FIG. 16-17.

The cartridge holder (600) comprises a spool (602) and a spool support (604). The spool support (604) is fixedly mounted to the handle (40) of the tool (10) with at least one fastener (606). In this first alternative embodiment, two fasteners (606) are bolted through a first end (616) of the spool support. Each of the two fasteners (606) extend through a bore (42) that extends through the handle (40) of the tool (10). The handle (40) may be configured to accept such an attachment as described above. In other embodiments, two holes may be drilled through a handle of an existing tool to retrofit the existing tool to accept the cartridge holder (600).

The spool support (604) comprises a first panel (608), a second panel (610), and a second strip guide (614). The first and second panels (608, 610) extend transversely from the handle (40) parallel to one another. The first and second panels (608, 610) extend from the first end (616) positioned proximate to the handle (40) to a second end (618) that is positioned distal relative to the handle (40). The spool (602) is directly fitted between the first and second panels (608, 610). The second strip guide (614) is operatively fastened between the first and second panels (608, 610).

The second strip guide (614) includes a pivot (612) that allows the second strip guide (614) to rotate about an axis that is orthogonal to the longitudinal axis (LA) of the tool (10). The spool (602) includes a plurality of protrusions (644) and an elongate shaft (640). In the first alternative embodiment, the spool (602) is hung directly from the first and second panels (608, 610). The spool (602) further includes a pair of fasteners (636) positioned at the distal ends of the spool (602).

One of the pair of fasteners (636) extends from a first end (632) and another fastener (636) extends from the second end (642) of the elongate shaft (640). The fasteners (636) when tightened within the first and second ends (632, 642) extend beyond the first and second ends (632, 642). The fasteners (636) are configured to retain the spool (602) within the spool support (604). The width of the spool (602) with the fasteners (636) is greater than the width between the first and second panels (608, 610). Each of the planar panels includes a notch (627) having a “fish mouth” shape that extends inwardly from the second end (618) to a plurality of circular apertures (624, 628, 630). A cutaway (626) extends between each of the circular apertures (624, 628, 630) so that the fasteners (636) may be transitioned from the notch (627) to an outer circular aperture (624), further to a median circular aperture (628), and further to an inner circular aperture (630) that is positioned more proximal to the handle (40).

The spool (602) is transversely fitted through the notch (627) and rests within one of the circular apertures (624, 628, 630) of the plurality of circular apertures (624, 628, 630). Gravity retains the spool (602) within the spool support (604). The fastener (636) includes a head and a shaft. The shaft rests within the circular apertures (624, 628, 630). The first and second ends (632, 642) of the spool (602) transversely locate the spool between the first and second panels (608, 610) and the heads of the fasteners (636) transversely locate the spool (602) between the first and second panels (608, 610). The spool (602) supports the screw cartridge (70). If the screw cartridge (70) includes a larger diameter relative to another screw cartridge (70), the spool (602) will be placed in a circular aperture (624, 628, 630) that is further from the handle (40) to provide more room to allow the screw cartridge (70) to rotate freely. Screw cartridges (70) fitted to the spool (602) that includes a relatively smaller number of screws (64), the spool (602) will be placed in a circular aperture (624, 628, 630) that is closer to the handle (40). In other embodiments, the spool (602) may be fastened to a pair of hubs that rest within the circular apertures (624, 628, 630).

Similar to the cartridge holder (200) the screw strip (60) is fed through the second strip guide (614), and further through the bottom guide rail (32) of the tool (10). The second strip guide (614) differs from the second strip guide (614) because the second strip guide includes a pivot (612) that helps align the screw strip (60) with the bottom guide rail (32) and the screw strips (60) leave the screw cartridge (70) in an orientation that is similar to the orientation of the screw strip (60) after the screw strip (60) leave the second strip guide (614).

### Second Alternative Embodiment

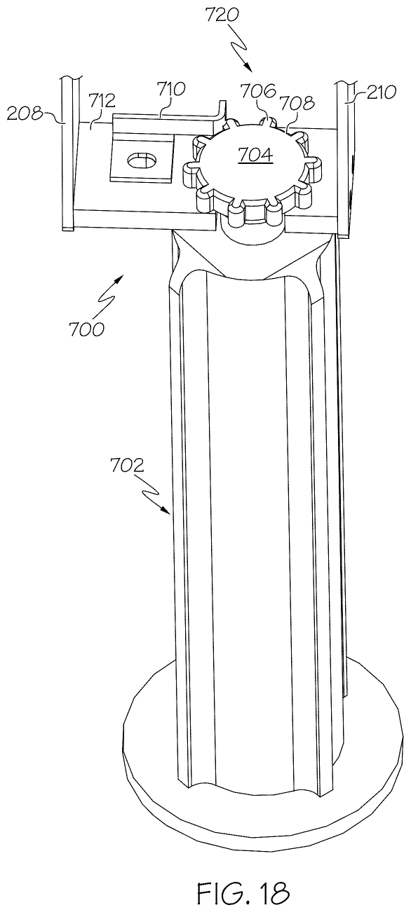

Referring now FIG. 18, a portion of a second alternative embodiment cartridge holder (700) that includes a clutch (720) that may be fitted to a spool holder (712) that is adapted for a clutch (720) of the autofeed screwdriver assembly (1, 2). The clutch (720) includes a gear (704) having protrusions (706) and a base circle (708). The gear (704) is positioned above the spool (202). It should be noted that the spool may be vertically positioned relative to a workpiece as shown in FIGS. 1-7 (i.e., the first embodiment assembly 1) or horizontally positioned relative to a workpiece as shown in FIGS. 16-17 (i.e., the first alternative embodiment assembly 2).

The clutch (720) further includes an interference rod (710) that is operatively secured to the spool holder (712). The interference rod (710) includes a bent rod that engages the gear (704). The interference rod (710) is malleable must deflect in order for the spool (202) to rotate. When the interference rod (710) is positioned upon the base circle (708) between two of the protrusions (706) the screw cartridge (70) is prevented from rotating until the force created by the sprocket that feeds the screw strip (60) into the tool (10) is able to overcome the resistance of the interference rod (710), which causes the interference rod (710) to deflect. This prevents the screw cartridge (70) from rotating in a direction that is opposite of the direction of rotation of the normal direction of rotation when the screw strip (60) is removed from the spool (702). When the interference rod is deflected, it rides over the next protrusion (706) keeping the screw strip (60) taut to prevent slack. Keeping the screw strip (60) taut enables precise feeding of the screw strip (60) into the tool (10) which prevents jamming or unnecessarily unraveling of the screw strip (60).

### Third Alternative Embodiment

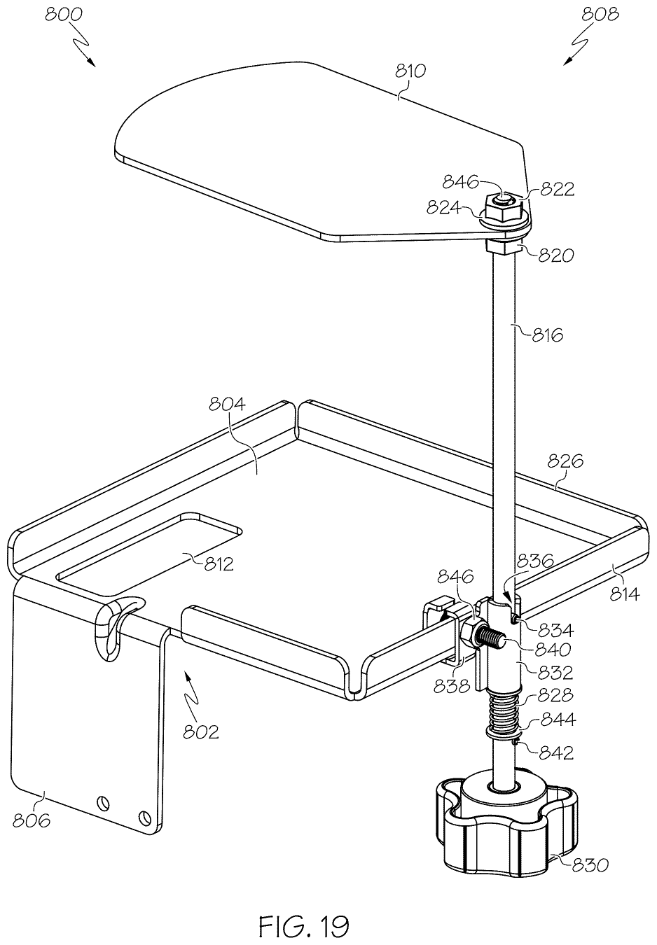

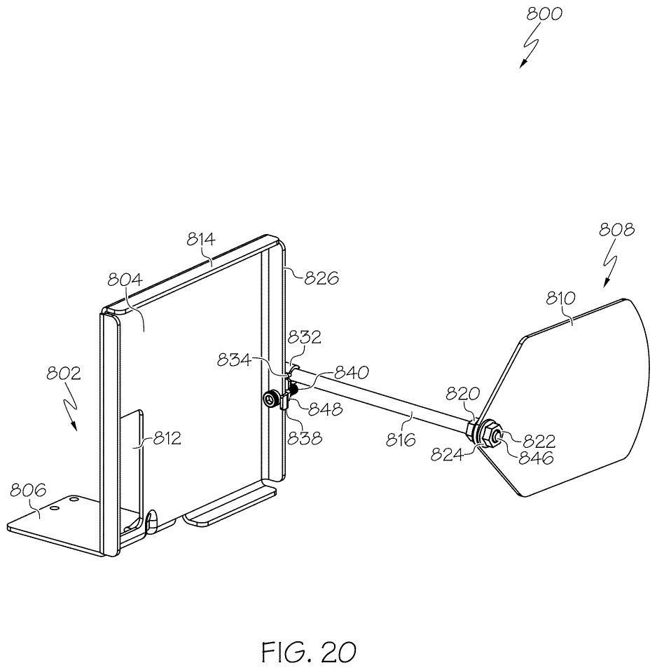

Referring now to FIGS. 19-20, shows a third alternate embodiment in the closed configuration. The third alternate embodiment includes a receptacle support (800) similar to the receptacle support (500). Receptacle support (800) is similar to receptacle support (500), in that receptacle support (800) may be loaded with the strip receptacle (402) to retain the “spent” plastic strip (62) after the screws (64) are removed from the plastic strip (62) and have been screwed into the workpiece. Similar to the receptacle support (500), the receptacle support (800) includes a bracket (802) having a mounting plate (804), a securing plate (806), and a rotatable coupling (808). The mounting plate (804) is integrally formed with the securing plate (806) from a rigid material such as metal or hard plastic, for example.

The mounting plate (804) extends parallel to the second mount panel (104) (not shown). The securing plate (806) extends transversely from the mounting plate (804). The mounting plate (804) and securing plate (806) may be integrally formed together, or the mounting plate (804) may be separately formed and the mounting plate (804) is fastened to the securing plate (806) with fasteners (not shown). The securing plate (806) defines a rectangular cutaway (812) and at least one first pair of plates (814). The securing plate (806) optionally may include a second pair of plates (826). In some versions, one or more of the first and second pair of plates (814, 826) may be shorter or longer than one another. As shown, the second plate (826) near the rectangular cutaway is shorter than the second plate (826) positioned on the opposite side of the mounting plate (804). The rectangular cutaway (812) is configured to accept the first strip guide (130) therethrough. The first pair of plates (814) are configured to transversely locate the strip receptacle (402) in a first direction within the receptacle support (800) and the second pair of plates (826) transversely locate the strip receptacle (402) in a second direction that is transverse to the first direction.

The rotatable coupling (808) of receptacle support (800) differs in form and operation from the rotatable coupling (508). The rotatable coupling (808) is operatively coupled to the securing plate (506) by a clamp (838). As shown, the clamp (838) is removably fastened to one of the first or second pair of plates (814, 826) with a fastener (840) that extends through the clamp (838) and one of the first or second pair of plates (814, 826). The fastener (840) is tightened to secure the rotatable coupling (808) to the first or second pair of plates (814, 826). The clamp (838) also defines a bore that is configured to accept the fastener (840). The rotatable coupling may also be welded or otherwise attached to the bracket (802) in lieu of being bolted. A bracket (848) attaches the clamp (838) to the bushing (832) so that the bushing (832) is fixed relative to the bracket (848). The bracket (848) is a planar and is constructed of metal. The bracket (848) as shown is integrally formed with the bushing (832) and the clamp (848) or may be attached by another permanent means that is known in the art.

The rotatable coupling (808) includes a rear plate (810), a pair of female fasteners (820, 822), a rod (816), a bushing (832), a spring (828), a first locating pin (834), a second locating pin (842), an engagement surface in the form of a washer (844), and a knob (830). The rear plate (810) includes a planar configuration and is shaped similarly to the rear plate (510) and defines a plate bore (824). The plate bore (824) is sized large enough to allow rod (816) to pass through the plate bore (824) but is small enough to engage the second and third female fasteners (520, 522) without allowing the second and third female fasteners (520, 522) to pass through the plate bore (824). The rod (816) extends from a threaded end portion (846) that is positioned near a top of the rotatable coupling (808) to a knob (830) that is positioned near a bottom of the rotatable coupling (808) as illustrated. The threaded end portion (846) extends from the free end of the rod (816) downwards along the rod (816) and includes enough length to allow the female fasteners (820, 822) to tighten on opposite sides of the plate bore (824). Once the female fasteners (820, 822) are tightened on opposite sides of the plate the rear plate (810) is fixedly positioned relative to the rod (816). The remaining portion of the rod (816) that is positioned below the threaded end portion (846) is not threaded. The rod (816) extends from the threaded end portion (846) to the handle (830). The handle (830) is formed of hard plastic or metal and includes portions configured to allow a user to grip the handle and turn the handle. The handle (830) is operatively fastened to the rod (816) with any means known in the art to fasten a handle to a rod, including but not limited to using at least one fastener, press fit, molding the knob upon the rod (816), and using a keyway in combination with a fastener. The handle (830) allows a user to rotate the rod (816).

The rotatable coupling has two operative positions. The first position (see FIG. 19) further referred to as the “closed position” is configured to the retain the strip receptacle (402) within the receptacle support (800). The second position (see FIG. 20) further referred to as the “open position” is configured to release the strip receptacle (402) from the receptacle support (800). The rod (816) extends through the bushing (832) located between the threaded end portion (846) and the knob (830). The second locating pin (842) is positioned below the washer (844); the washer (844) is positioned below the spring (828); the spring (828) is positioned below the bushing (832), the bushing (832) is positioned below the first locating pin (834); and the first locating pin (834) is positioned above the bushing.

The second locating pin (842) retains the washer (844) so that the spring (828) remains partially compressed at all times. The spring (828) being compressed applies an axial force to the rod (816) in a downward direction. The spring (828) translates the washer (844) away from the bushing (832) forcing the rod (816) downwards. In the first position, the first locating pin (834) is translated downwards within the recess (836) that is defined by an upper portion of the bushing (832). This also translates the rear plate (810) against a strip receptacle (402) when a strip receptacle (402) is fitted within the receptacle support (800). The receptacle support (800) may be transitioned to the second state (see FIG. 20) by applying enough axial force to the knob (830) in an upwards direction that the user's axial force upon the knob (830) overcomes the axial force of the spring (828), and the rod (816) is translated upwards. The first locating pin (834) is moved vertically above the top of the bushing (832). While the spring (828) is compressed, the knob (830) may be rotated 180 degrees until the first locating pin (834) is aligned with the recess (836). The knob (830) is then released, which allows the first locating pin (834) to translate downwards within the recess (836). It should be noted that the first locating pin (834) extends from both sides of the rod (816) to a distance that is long enough so that the first locating pin (834) may engage the recess (836) that is in the first or the second position.

As shown in FIG. 20 the rear plate (810) is rotated to a position that allows the strip receptacle (402) to be freely inserted or removed from the receptacle support (800). The receptacle support (800) may further be transitioned from the second position (see FIG. 20) back to the first position (see FIG. 19) by again moving the knob (830) in the vertical direction and rotating the knob 180 degrees. In some instances, it may be advantageous to move the knob (830) in the vertical direction and rotate the knob (830) less than 180 degrees ton transition the receptacle support (800) from the first position to a third position. The third position is known as an “intermediate position.” After rotating the knob (230) less than 180 degrees, the knob (830) is released and the first locating pin (834) engages a top portion of the bushing (832). The intermediate position allows the rear plate (810) to be rotated to position where the rear plate (810) does not interfere with the changing of the strip receptacle (402), but also does not require a full 180 rotation of the knob (830). In the intermediate position, the rear plate (810) is moved 90 degrees from the first position, for example. In the intermediate position, the knob (830) does not need to be moved in the vertical position to transition back to the first or second position. The knob (830) merely needs to be rotated enough for the first locating pin (834) to fall into the recess (836). The first locating pin (834) falls into the recess (836) because of the axial force of the spring (828).

### Screw Cartridge

FIG. 21 shows a more realistic version of the screw cartridge (70) depicted in FIGS. 1, 3, 10, 11D-11E, and 12C-12F. FIG. 21 includes details not shown in the previous depictions of screw cartridge (70). The current depiction of screw cartridge (70) includes a higher the number of screws (64) and a plurality of notches (74). The each of the plurality of notches (74) are evenly spaced apart from one another on the upper and lower surfaces of the plastic strip (62). The notches (74) allow the autofeed screwdriver tool (10) feed the screw strip (60) into the tool. The notches (74) engage a rotating gear or cog of the autofeed screwdriver tool (10) to moves the screw strip (60) into the autofeed screwdriver tool (10). This movement facilitates the alignment of the screws (64) with the driver. Once the screws (64) are aligned with the driver, the screws (64) are fastened into a workpiece. It should be noted that FIG. 21 is not an exact depiction of the screw cartridge (70), that further details of the screw cartridge (70) were omitted for clarity. For example, an exact depiction of the cartridge (70) would include more wraps (72) of screws strips (60) and therefore more screws (64) would be contained in the screw cartridge (70). The dimeter of these wraps (72) may also be greater relative to the size of the screw head (66) or screw length. The screw cartridge (70) actually includes approximately 100 to approximately 1000 screws, approximately 200 to approximately 900 screws, approximately 300 to approximately 700 screws, approximately 400 to approximately 600 screws, and more specifically approximately 500 screws. This number of screws (64) is made possible with more wraps (72), a larger diameter, and tighter spacing between the screws (64) than depicted in FIG. 21.

Some of the mechanical mechanisms described above for the portable fastener driving tool 10 have been available in the past from Senco Products, Inc. and Senco Brands, Inc., including such tools as the Senco Model Nos. DS162-14V and DS200-14V. Some of the components used in the technology disclosed herein have been disclosed in commonly-assigned patents or patent applications, including a U.S. Pat. No. 5,988,026 , titled SCREW FEED AND DRIVER FOR A SCREW DRIVING TOOL; a U.S. Pat. No. 7,032,482, titled TENSIONING DEVICE APPARATUS FOR A BOTTOM FEED SCREW DRIVING TOOL FOR USE WITH COLLATED SCREWS; a U.S. Pat. No. 7,082,857, titled SLIDING RAIL CONTAINMENT DEVICE FOR FLEXIBLE COLLATED SCREWS USED WITH A TOP FEED SCREW DRIVING TOOL; a U.S. Pat. No. 8,869,656, titled SCREWDRIVER TOOL WITH IMPROVED CORNER FIT FUNCTION; a U.S. Pat. No. 8,627,749 , titled SCREWDRIVER TOOL WITH IMPROVED CORNER FIT FUNCTION; and a U.S. Pat. No. 8,726,765 , titled SCREWDRIVER TOOL WITH IMPROVED LINEAR TRACKING. These patent properties have been assigned to Senco Brands, Inc., or to Kyocera Senco Industrial Tools, Inc., and their disclosures are incorporated herein by reference in their entireties.

As used herein, the term “proximal” can have a meaning of closely positioning one physical object with a second physical object, such that the two objects are perhaps adjacent to one another, although it is not necessarily required that there be no third object positioned therebetween. In the technology disclosed herein, there may be instances in which a “male locating structure” is to be positioned “proximal” to a “female locating structure.” In general, this could mean that the two (male and female) structures are to be physically abutting one another, or this could mean that they are “mated” to one another by way of a particular size and shape that essentially keeps one structure oriented in a predetermined direction and at an X-Y (e.g., horizontal and vertical) position with respect to one another, regardless as to whether the two (male and female) structures actually touch one another along a continuous surface. Or, two structures of any size and shape (whether male, female, or otherwise in shape) may be located somewhat near one another, regardless if they physically abut one another or not; such a relationship could still be termed “proximal.” Or, two or more possible locations for a particular point can be specified in relation to a precise attribute of a physical object, such as being “near” or “at” the end of a stick; all of those possible near/at locations could be deemed “proximal” to the end of that stick. Moreover, the term “proximal” can also have a meaning that relates strictly to a single object, in which the single object may have two ends, and the “distal end” is the end that is positioned somewhat farther away from a subject point (or area) of reference, and the “proximal end” is the other end, which would be positioned somewhat closer to that same subject point (or area) of reference.

It will be understood that the various components that are described and/or illustrated herein can be fabricated in various ways, including in multiple parts or as a unitary part for each of these components, without departing from the principles of the technology disclosed herein. For example, a component that is included as a recited element of a claim hereinbelow may be fabricated as a unitary part; or that component may be fabricated as a combined structure of several individual parts that are assembled together. But that “multi-part component” will still fall within the scope of the claimed, recited element for infringement purposes of claim interpretation, even if it appears that the claimed, recited element is described and illustrated herein only as a unitary structure.

All documents cited in the Background and in the Detailed Description are, in relevant part, incorporated herein by reference; the citation of any document is not to be construed as an admission that it is prior art with respect to the technology disclosed herein.

The foregoing description of a preferred embodiment has been presented for purposes of illustration and description. It is not intended to be exhaustive or to limit the technology disclosed herein to the precise form disclosed, and the technology disclosed herein may be further modified within the spirit and scope of this disclosure. Any examples described or illustrated herein are intended as non-limiting examples, and many modifications or variations of the examples, or of the preferred embodiment(s), are possible in light of the above teachings, without departing from the spirit and scope of the technology disclosed herein. The embodiment(s) was chosen and described in order to illustrate the principles of the technology disclosed herein and its practical application to thereby enable one of ordinary skill in the art to utilize the technology disclosed herein in various embodiments and with various modifications as are suited to particular uses contemplated. This application is therefore intended to cover any variations, uses, or adaptations of the technology disclosed herein using its general principles. Further, this application is intended to cover such departures from the present disclosure as come within known or customary practice in the art to which this technology disclosed herein pertains and which fall within the limits of the appended claims.

1. An autofeed screwdriver attachment, comprising:
(a) a spool support configured to be fastened to a handle of an autofeed screwdriver, the spool support including:
(i) a first panel mounted to a first side of the handle,
(ii) a second panel mounted to a second side of the handle, and
(iii) a spool hanger positioned between the first and second panel; and
(b) a spool including an elongate shaft extending vertically from a first end to a second end, and a retainer that is fastened proximate to the first end of the elongate shaft and the elongate shaft is removably fitted to the spool hanger proximate to the second end; wherein:
the spool is configured to retain a screw cartridge above the retainer.

2. The autofeed screwdriver attachment of claim 1, further comprising: the screw cartridge positioned within a container in a coiled configuration, in which the screw cartridge includes a flexible screw strip that retains a plurality of screws a set distance apart from one another, and each screw includes a tip that faces inwards towards the spool; and the screw cartridge remains in the coiled configuration both the spool captures the screw cartridge from the container and when the spool installed within the spool hanger.

3. The autofeed screwdriver attachment of claim 2, further comprising: a guide positioned between the first and second panel; wherein:
the guide is configured to orient the tip of each screw in a bottom direction before the flexible screw strip enters a bottom guide that further directs the screw strip towards a bottom end of an autofeed screwdriver.

4. The autofeed screwdriver attachment of claim 1, wherein: the elongate shaft further includes at least one protrusion that adjoins at least one recess, the at least one protrusion and the at least one recess extend along a length of the elongate shaft.

5. The autofeed screwdriver attachment of claim 1, wherein: the spool further includes a hub configured to rotate with a predetermined amount of resistance when placed within a circular aperture defined by the spool hanger.

6. The autofeed screwdriver attachment of claim 5, wherein: the hub includes a first hub diameter, a second hub diameter and a third hub diameter, and the spool support includes a notch having a notch width and the circular aperture being larger than the notch width; wherein:
the first hub diameter is smaller relative to the notch width so that the hub may be aligned with the first hub diameter and passed horizontally into the circular aperture;
the circular aperture is sized to complement the second hub diameter, and the circular aperture is sized smaller relative to the third hub diameter; and
the hub is aligned with the circular aperture so that the second hub diameter is vertically aligned within the circular aperture, and the third hub diameter engages a top surface of the spool hanger by gravitational force, thereby supporting the spool within the spool support.

7. (canceled)

8. The autofeed screwdriver attachment of claim 1, wherein: the spool is configured to hold a screw strip that include approximately 100 screws to approximately 1000 screws.

9. An autofeed screwdriver assembly, comprising:
(a) an autofeed screwdriver; and
(b) the autofeed screwdriver attachment of claim 1.

10. The autofeed screwdriver assembly of claim 9, wherein: the autofeed screwdriver comprises a front guide fastened to a front of the autofeed screwdriver, wherein: the front guide is configured to direct the flexible screw strip away from a distal end of the autofeed screwdriver after the screws have been secured into a workpiece.

11. The autofeed screwdriver assembly of claim 10, further comprising: a tool mount assembly configured to secure the autofeed screwdriver assembly to an automated industrial machine, the tool mount assembly including:
(i) a first mount panel extending along a longitudinal axis of the autofeed screwdriver assembly and is configured to directly mount to the automated industrial machine;
(ii) a second mount panel that extends along a front portion of the autofeed screwdriver and is fixedly coupled to the first mount panel; and
(iii) a pair of mount arms that wrap around the autofeed screwdriver to fixedly mount the second mount panel to the autofeed screwdriver.

12. (canceled)

13. (canceled)

14. (canceled)

15. A method of preparing a screw cartridge to be loaded into a screwdriver assembly, the method comprising:
(a) providing a container including a receptacle having at least one side panel extending upwards from a base panel to a top and defining an interior space, the base panel having a base aperture, and an insert having an insert aperture positioned between the base panel and the top within the interior space;
(b) positioning the screw cartridge within the interior space above the insert, wherein the screw cartridge comprises a flexible screw strip positioned in a coiled arrangement within the interior space;
(c) providing a spool extending from a first end to a second end, which includes a retainer proximal to the second end that exhibits a base diameter that is larger than the insert aperture, in which the first end is smaller in diameter than the base aperture and the insert aperture;
(d) inserting the spool upwards so that the first end extends through the base aperture, the insert aperture, and the screw cartridge; and
(e) displacing spatially the spool upwards through the top of the container to remove the screw cartridge from the container.

16. The method of claim 15, wherein: the retainer exhibits a diameter that is smaller relative to the base aperture and larger than the insert aperture, so that when the spool is moved upwards through the base aperture, the retainer passes through the base aperture and engages the insert thereby lifting the insert from an interior of the container, thereby removing the screw cartridge from the container.

17. The method of claim 15, further comprising:
(a) positioning a lid having a lid aperture above the screw cartridge and the first end of the spool extends through when the spool is inserted upwards.

18. The method of claim 15, further comprising:
(a) placing the spool that supports the screw cartridge within a spool hanger, wherein: the screw cartridge includes a screw strip and a plurality of screws, each individual screw of the plurality of screws includes a tip that faces the spool.

19. The method of claim 18, further comprising:
(a) providing a receptacle support that is secured to an autofeed screwdriver assembly; and
(b) securing the receptacle to the autofeed screwdriver assembly to retain the flexible screw strip after the screws are secured into a workpiece.

20. The method of claim 19, wherein: the receptacle is secured within the receptacle support by a rotatable coupling.

21. The method of claim 20, wherein: the receptacle of the container is positioned within the receptacle support with an open top of the receptacle positioned towards a cutaway in the receptacle support.

22. The method of claim 21, wherein: the rotatable coupling includes a planar surface that is larger than the base aperture so that when the rotatable coupling is rotated, the planar surface supports the receptacle and covers the base aperture to prevent the flexible screw strip from exiting the receptacle.

23. A screw cartridge, comprising:
a single screw strip that is flexible and retains a plurality of screws, each screw of the plurality of screws including a head and a tip, each head being retained and spaced apart a set distance from an adjacent head, and the single screw strip being positioned in a coiled arrangement with each tip facing inwards and the single screw strip generally forming an outside diameter of the coiled arrangement, wherein:
the plurality of screws includes approximately 100 to approximately 600 screws in the single screw strip;
the screw cartridge is configured to be retained for shipping in the coiled arrangement; and
the screw cartridge is configured to be loaded upon a spool of an attachment for an autofeed screwdriver in which the coiled arrangement is generally maintained.

24. The screw cartridge of claim 23, wherein: the coiled arrangement includes a generally helical shape.
